(19) United States
(12) Patent Application Publication
(10) Pub. No.: US 2014/0344051 A1
(43) Pub. Date: Nov. 20, 2014

(54) Commerce System and Method of Controlling the Commerce System Using One-to-One Offers and Profit Sharing

(71) Applicant: MyWorld, Inc., Scottsdale, AZ (US)

(72) Inventor: Kenneth J. Ouimet, David, CA (US)

(73) Assignee: MyWorld, Inc., Scottsdale, AZ (US)

(21) Appl. No.: 13/897,121

(22) Filed: May 17, 2013

(51) Int. Cl. G06Q 30/02

(52) U.S. Cl. CPC G06Q 30/0247
USPC 705/14.46

(57) ABSTRACT

A commerce system has retailers offering products for sale to consumers. A consideration set including a plurality of products is provided. An interface is provided to submit a profit share corresponding to each of the products. The products are evaluated to determine a discount for each of the products. A first product is selected from the products including a largest profit share. The commerce system is controlled by distributing the largest profit share, an incremental profit corresponding to the first product, and a shopping list including the first product. A value of each of the products is determined to identify a maximum value. The discount is determined for each of the products to increase the value of each of the products to the maximum value. The set of products is accessed to provide a price per use for each of the products.

### FIELD OF THE INVENTION

The present invention relates in general to consumer purchasing and, more particularly, to a commerce system and method of controlling the commerce system using one-to-one offers and profit sharing.

### BACKGROUND OF THE INVENTION

Grocery stores, general merchandise stores, specialty shops, and other retail outlets face stiff competition for limited consumers and business. Most, if not all, retail stores expend great effort to maximize sales, revenue, and profit. Effective use of promotion budget is critical to increasing profit. Yet, as an inherent reality of commercial transactions, the benefits bestowed on the retailer often come at a cost or disadvantage to the consumer. Maximizing sales and profits for a retailer does not necessarily expand competition and achieve the lowest price for the consumer.

Retailers face economic risk when promoting products to consumers using traditional price discounts. In the past, retailers have made generic offers to an entire population or group of consumers. Coupons published in a newspaper or on a website exemplify traditional discount offers made to large groups of consumers. Any consumer that desires to purchase the product from the retailer can search online or locate the newspaper to find a coupon that the retailer has made publicly available. Consumers purchase the product using a coupon, even though the same consumer would have otherwise purchased the product at a higher price. By making generic offers readily available to the public, the retailer risks losing the profit from sales to consumers that would purchase the product even absent the discount.

Retailers must also consider the expenses and time required to run a successful marketing campaign based on offering discounts. A retailer offering a generic discount on a product must determine what size of discount to offer, whether the offer should be delivered by radio, television, email, newspaper, text message, web site, mail, or another medium, and which groups of consumers should receive the offer. After determining the delivery method and targets, the retailer faces the cost of distributing the discount offers. The retailer generally must pay for distribution regardless of the success of a promotion, exposing the retailer to economic risk if the promotion is unsuccessful. The offering retailer is also subject to economic risk associated with reduced profit margin on sales subject to the discount, particularly if more consumers use the coupon than the retailer budgeted for.

On the other side of the transaction, consumers face decision stress associated with the demands of everyday shopping. An overwhelming number of products exist that might satisfy a want or need. For example, the average family spends nearly $10,000 at grocery stores in a given year. The average item at a grocery store costs just $3.00. That means the shopper for a family has makes purchasing decisions on roughly 3,000 products per year. Given the vast selection available in most product categories, the average shopper has 300,000 to 1,000,000 product options per year at the grocery store. The number of products available is far too high for an individual consumer to adequately consider each product, much less identify the best options. Even if a shopper could consider a million different options in a year, the economic viability of the process would eliminate any value in evaluating low-cost items. As a result, shoppers often purchase the same product at the same location without actually considering whether another product or retailer offers a better value. The consumer is leaving value on the table.

The consumers are interested in quality, low prices, comparative product features, convenience, and receiving the most value for the money. However, consumers have a distinct disadvantage in attempting to compile models for their benefit. Retailers have ready access to the historical transaction log (T-LOG) sales data, consumers do not. The advantage goes to the retailer. The lack of access to comprehensive, reliable, and objective product information essential to providing effective comparative shopping services restricts the consumer's ability to find the lowest prices, compare product features, and make the best purchase decisions.

For the consumer, some comparative product information can be gathered from various electronic and paper sources, such as online websites, paper catalogs, and media advertisements. However, such product information is sponsored by the retailer and slanted at best, typically limited to the specific retailer offering the product and presented in a manner favorable to the retailer. That is, the product information released by the retailer is subjective and incomplete, i.e., the consumer only sees what the retailer wants the consumer to see. For example, the pricing information may not provide a comparison with competitors for similar products. The product descriptions may not include all product features or attributes of interest to the consumer.

Alternatively, the consumer can visit all retailers offering a particular type of product and record the various prices, product descriptions, and retailer amenities to make a purchase decision. The brute force approach of one person physically traveling to or otherwise researching each retailer for all product information is impractical for most people. Many people do compare multiple retailers, e.g., when shopping online, particularly for big-ticket items. Yet, the time people are willing to spend reviewing product information decreases rapidly with price. Little time is spent reviewing commodity items. In any case, the consumer has limited time to do comparative shopping and mere searching does not constitute an optimization of the purchasing decision. Optimization requires access to data, i.e., comprehensive, reliable, efficient, and objective product information, so the consumer remains hampered in achieving a level playing field with the retailer.

Consumers often are faced with constraints such as budgets, product availability, and retailer locations when making purchasing decisions. The retail location where the consumer is shopping may not provide the same substitutions as competitors and may have higher pricing on desired goods. A need exists to optimize consumers' shopping lists in light of real world constraints including product availability, retailer locations, and pricing.

In a highly competitive market, the profit margin is paper-thin and consumers and products are becoming more differentiated. Consumers are often well informed through electronic media and will have appetites only for specific products. Retailers must understand and act upon the market segment, which is tuned into their niche product area to make effective use of marketing dollars. The traditional mass marketing approach using gross market segmentation is insufficient to predict consumer behavior across the various market segments accurately. A more refined market strategy focuses resources on specific consumers that have the greatest potential of achieving a positive purchasing decision by the consumer for a particular product. Often times, retailers have room to discount a certain product on an individual basis, but have no way of optimizing that discount for a particular consumer. The retailers remain motivated to optimize marketing strategy, particularly pricing strategy, to maximize profit and revenue.

From the consumer's perspective, purchasing products from retailers can be both time-consuming and stressful. With limited budgets and time, consumers desire to be as efficient as possible. Consumers want to purchase products at the best possible price, but often do not have time to compare prices at many different retail outlets before purchasing. Furthermore, searching for the lowest price for a particular product among retailers can be a difficult task, since accurate and reliable pricing data is often difficult to obtain. Additionally, the process of compiling and reviewing what little useful information is readily available to the consumer far exceeds any benefit the consumer might derive from the information.

### SUMMARY OF THE INVENTION

A need exists to provide a mechanism to assist consumers by determining the most valuable product options fulfilling consumer needs from various retailers. Accordingly, in one embodiment, the present invention is a method of controlling a commerce system comprising the steps of providing a consideration set including a plurality of products, providing an interface to submit a profit share corresponding to each of the products, evaluating the products to determine a discount for each of the products, selecting a first product from the products including a largest profit share, and controlling the commerce system by distributing the largest profit share, an incremental profit corresponding to the first product, and a shopping list including the first product.

In another embodiment, the present invention is a method of controlling a commerce system comprising the steps of providing a set of products, providing an interface to submit a profit share corresponding to each of the products, selecting a first product from the products including a largest profit share, and controlling the commerce system by distributing an incremental profit corresponding to the first product and a shopping list including the first product.

In another embodiment, the present invention is a method of controlling a commerce system comprising the steps of providing a set of products including a profit share for each product, selecting a product from the set of products based on the profit share, and distributing an incremental profit corresponding to the selected product.

In another embodiment, the present invention is a computer program product usable with a programmable computer processor having a computer readable program code embodied in a non-transitory computer usable medium for controlling a commerce system comprising the steps of providing a set of products, providing an interface to submit a profit share corresponding to each of the products, selecting a first product from the products including a largest profit share, and controlling the commerce system by distributing an incremental profit corresponding to the first product and a shopping list including the first product.

### BRIEF DESCRIPTION OF THE DRAWINGS

FIG. 1 illustrates a commerce system that analyzes T-LOG data to generate demand models and executes a business plan in accordance with those demand models;

FIG. 2 illustrates a commercial supply, distribution, and consumption chain controlled by a demand model;

FIG. 3 illustrates commercial transactions between consumers and retailers with the aid of a consumer service provider;

FIG. 4 illustrates an electronic communication network between the consumers and consumer service provider;

FIG. 5 illustrates a computer system operating with the electronic communication network;

FIG. 6 illustrates a consumer service provider creating an optimized shopping list for a consumer;

FIGS. 7a-7c illustrate consumer service provider providing retailer agents and consumer agents to negotiate one-to-one offers;

FIG. 8 illustrates consumer service provider identifying a one-to-one discount for a consumer and an incremental profit for a retailer using consumer and retailer agents;

FIGS. 9a-9c illustrate an interface for a consumer to submit intent-to-buy information;

FIGS. 10a-10b illustrate consumer service provider determining optimum discounts for each product that satisfy the intent to buy of an individual consumer;

FIG. 11 illustrates an interface for a retailer to submit a maximum discount and profit share;

FIGS. 12a-12b illustrate a maximum discount and profit share information submitted by multiple retailers and the resulting selection of a one-to-one offer;

FIGS. 13a-13b illustrate a maximum discount and profit share information submitted by multiple retailers and the resulting selection of a one-to-one offer;

FIGS. 14a-14b illustrate demand curves of price versus unit sales;

FIG. 15 illustrates an interface for a consumer to review individualized offers and selected products on an optimized shopping list from consumer service provider; and

FIG. 16 illustrates the process of controlling activity within the commerce system by providing optimized shopping lists with one-to-one offers.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors, most, if not all, businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

Retailers face economic risk when promoting a product to consumers using traditional price discounts. In the past, retailers have made generic offers to an entire population or group of consumers. Coupons published in a newspaper or on a website exemplify traditional discount offers distributed to large groups of consumers. Any consumer that desires to purchase the product from the retailer can search online or locate the newspaper to find a coupon that the retailer has made publicly available. Consumers purchase the product using a coupon, even though the same consumer would have otherwise purchased the product at a higher price. By making generic offers readily available to the public, the retailer risks losing the profit from sales to consumers that would purchase the product even absent the discount.

Retailers must also consider the investment required to run a successful marketing campaign based on offering discounts. A retailer offering a generic discount on a product must determine what size of discount to offer, whether the offer should be delivered by radio, television, email, newspaper, text message, web site, mail, or another medium, and which groups of consumers should receive the offer. After determining the delivery method and targets, the retailer faces the cost of distributing the discount offers. The retailer generally must pay for distribution regardless of the success of a promotion, exposing the retailer to economic risk if the promotion is unsuccessful. The offering retailer is also subject to economic risk associated with reduced profit margin on sales subject to the discount, particularly if more consumers use the coupon than the retailer budgeted for.

On the other side of the transaction, consumers face decision stress associated with the demands of everyday shopping. An overwhelming number of products exist that might satisfy a consumer want or need. For example, the average family spends nearly $10,000 at grocery stores in a given year. The average item at a grocery store costs approximately $3.00. That means the shopper for a family makes purchasing decisions on roughly 3,000 products per year. Given the vast selection available in most product categories, the average shopper has 300,000 to 1,000,000 product options per year at the grocery store. The number of products available is far too high for an individual consumer to adequately consider each product every time they make a purchase, much less identify the best options. Even if a shopper could consider a million different options in a year, the time requirements would eliminate any economic viability of comparatively evaluating low-cost items. As a result, shoppers often purchase the same product at the same location without considering whether another product or retailer offers a better value. The consumer is leaving value on the table.

For example, two cereal companies offer competing cereal products. The first company offers a first cereal product for $5.00. Consumer 62 purchases the first cereal product on most trips to the grocery store without comparison to other products, including the second cereal product offered by the second retailer, because the time spent analyzing relative value is not worth the increased value to consumer 62. The second retailer offers the second cereal product for $6.00 and authorizes consumer service provider 72 to offer a discount of $2.00 on the second cereal product with a profit share of 5%. In other words, the second retailer is willing to sell the second cereal product for $4.00. The consumer would purchase the second cereal product if the price were $4.99 or less. Consumer service provider 72 offers consumer 62 a discount of $1.01 to bring the price of the second cereal product to $4.99, the exact point at which consumer 62 would switch to the second cereal product. Consumer 62 purchases the second cereal product at $4.99 instead of the first cereal product and receives a better value than if consumer 62 purchased the first cereal product at $5.00. Consumer 62 receives the greater value without having to compare the first and second cereal products on his own. The retailer makes an additional sale at $4.99 without over discounting the second cereal product to $4.00, resulting in an additional $0.99 in incremental profit over the maximum discount authorized by the retailer. The retailer made the additional sale and avoided the economic risk of over discounting by providing a maximum discount and a profit share to consumer service provider 72. Consumer service provider 72 gets 5% of the incremental profit of $0.99, or $0.05. Thus, the discount offer from consumer service provider aligns the interests of the consumer, the retailer, and the consumer service provider.

Modeling the behavior of consumers is used to evaluate the large number of shopping options available to the average consumer. A consumer model for the consumer predicts the outcome of a retailer offer and automates the pre-shopping process for consumers. While the present discussion will involve a retailer and consumer, it is understood that the system described herein is applicable to data analysis for other members in the chain of commerce, or other industries and businesses having similar goals, constraints, and needs.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impact from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the product and transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

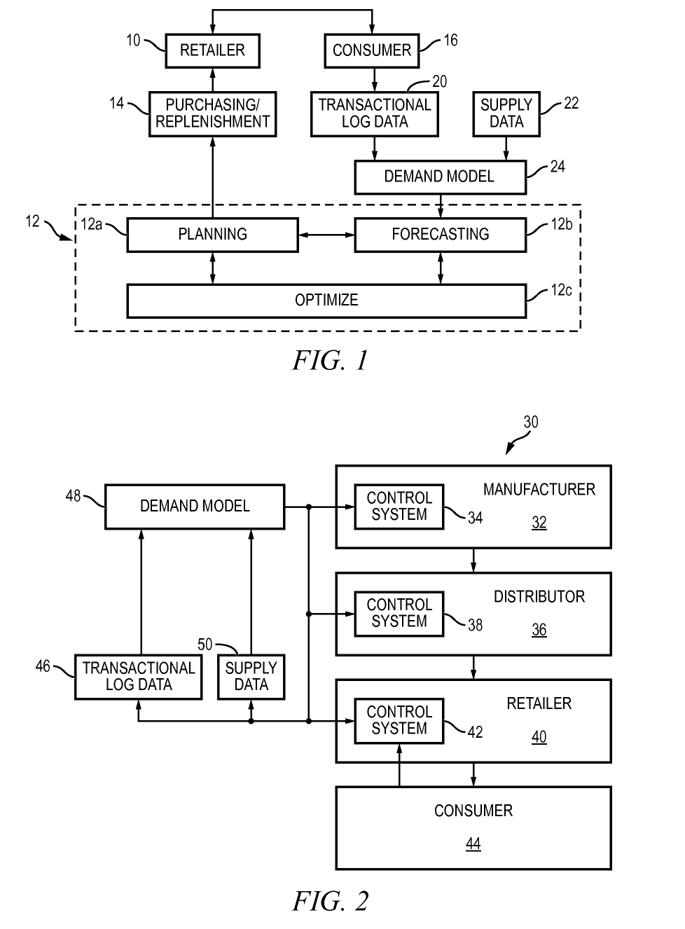

Referring to FIG. 1, retailer 10 has certain product lines or services available to consumers as part of its business plan 12. The terms products and services are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sale transaction entered into between retailer 10 and consumer 16, information describing the transaction is stored in T-LOG data 20. When a consumer goes through the checkout at a grocery or any other retail store, each of the items to be purchased is scanned and data is collected and stored by a point-of-sale (POS) system, or other suitable data storage system, in T-LOG data 20. The data includes the then current price, promotion, and merchandizing information associated with the product along with the units purchased, and the dollar sales. The date and time, and store and consumer information corresponding to that purchase are also recorded.

T-LOG data 20 contains one or more line items for each retail transaction, such as those shown in Table 1. Each line item includes information or attributes relating to the transaction, such as store number, product number, time of transaction, transaction number, quantity, current price, profit, promotion number, and consumer category or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 20 is accurate, observable, and granular product information based on actual retail transactions within the store. T-LOG data 20 represents the known and observable results from the consumer buying decision or process. T-LOG data 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.80 | 0.05 | PROMO2 | C1 |
| S1 | P3 | D1 | T1 | 3 | 3.00 | 0.40 | PROMO3 | C1 |
| S1 | P4 | D1 | T2 | 4 | 1.80 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T1 | 5 | 1.50 | 0.20 | PROMO1 | C4 |
| S2 | P7 | D3 | T1 | 1 | 5.00 | 1.10 | PROMO5 | C5 |
| S2 | P1 | D3 | T2 | 2 | 1.50 | 0.20 | PROMO1 | C6 |
| S2 | P8 | D3 | T2 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.80 each and three products P3 at price $3.00 each. In transaction T2 on day/time D1, consumer C2 has four products P4 at price $1.80 each and one product P5 at price $2.25. In transaction T3 on day/time D1, consumer C3 has ten products P6 at $2.65 each, in his or her basket. In transaction T1 on day/time D2 (different day and time) in store S1, consumer C4 purchases five products P1 at price $1.50 each. In store S2, transaction T1 with consumer C5 on day/time D3 (different day and time) involves one product P7 at price $5.00. In store S2, transaction T2 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T1 on day/time D3 has promotion PROMO5 as a $0.50 rebate. Product P8 in transaction T2 has no promotional offering. A promotion may also be classified as a combination of promotions, e.g., flyer with sale price, end-cap with rebate, or individualized discounted offer as described below.

Retailer 10 may also provide additional information to T-LOG data 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG data 20 and supply data 22 collected, various suitable methods or algorithms can be used to analyze the data and generate demand model 24. Model 24 may use a combination of linear, nonlinear, deterministic, stochastic, static, or dynamic equations or models for analyzing T-LOG data 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandise and assortment planning, seasonal and holiday variance, and replenishment optimization. Model 24 has a suitable output and reporting system that enables the output from model 24 to be retrieved and analyzed for updating business plan 12.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 26. Retailer 40 sells goods to consumer 44. Consumer 44 patronizes retailer's establishment either in person or by using online ordering. The consumer purchases are entered into control system 42 of retailer 40 as T-LOG data 46.

The purchasing decisions made by consumer 44 drive the manufacturing, distribution, and retail portions of commerce system 30. More purchasing decisions made by consumer 44 for retailer 40 lead to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG data 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed discounted offer, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed discounted offer, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

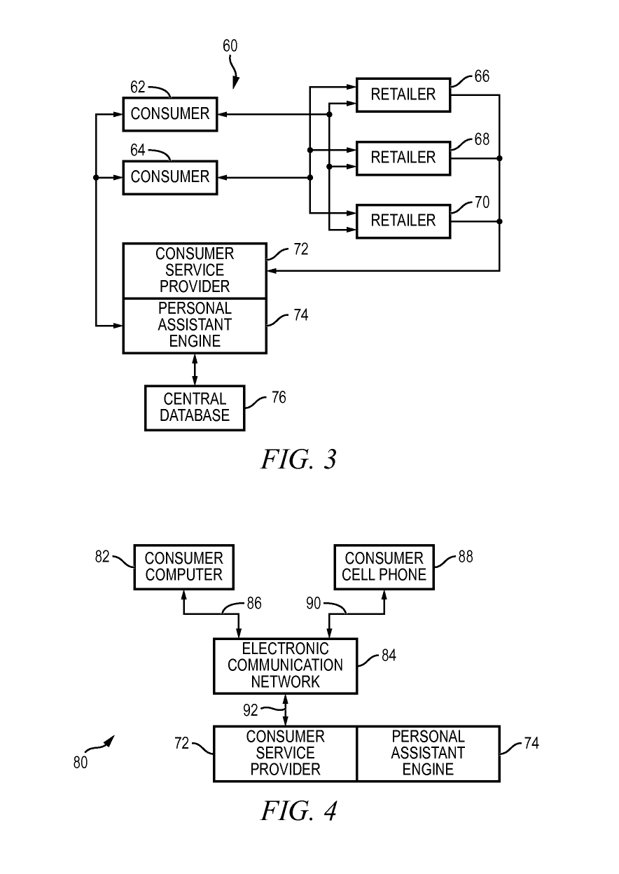

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transactions handled by electronic communication medium, e.g., phone or online website via personal computer, and delivered electronically or by common carrier, depending on the nature of the goods. Consumers 62-64 patronize retailers 66-70 either in person in the retailer's store or by electronic communication medium to select one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 can engage in regular commercial transactions within commerce system 60.

As described herein, manufacturer 32, distributor 36, retailers 66-70, consumers 62-64, and consumer service provider 72 are considered members of commerce system 60. The retailer generally refers to the seller of the product and consumer generally refers to the buyer of the product. Depending on the transaction within commerce system 60, manufacturer 32 can be the seller and distributor 36 can be the buyer, or distributor 36 can be the seller and retailers 66-70 can be the buyer, or manufacturer 32 can be the seller and consumers 62-64 can be the buyer.

Each consumer goes through a product evaluation and purchasing decision process each time a particular product is selected for purchase. Some product evaluations and purchasing decision processes are simple and routine. For example, when consumer 62 is conducting weekly shopping in the grocery store, the consumer sees a needed item or item of interest, e.g., canned soup. Consumer 62 may have a preferred brand, size, and flavor of canned soup. Consumer 62 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective model or comparative shopping service. The model must assist the consumer in finding the optimal price and product attributes, e.g., brand, quality, quantity, size, features, ingredients, service, warranty, and convenience, that are important to the consumer and tip the purchasing decision toward selecting a particular product and retailer.

In FIG. 3, consumer service provider 72 is a part of commerce system 60. Consumer service provider 72 is a third party that assists consumers 62-64 with the product evaluation and purchasing decision process by providing access to an optimization model or comparative shopping service. Consumer service provider 72 works with consumers 62-64 and retailers 66-70 to control commercial transactions within commerce system 60 by optimizing the selection of products by price and other attributes. More specifically, consumer service provider 72 operates and maintains personal assistant engine 74 that prioritizes product attributes and optimizes product selection according to consumer-weighted preferences. The product attributes and consumer-weighted preferences are stored in central database 76. In addition, personal assistant engine 74 generates a discounted offer for a product to entice a positive purchasing decision by a specific consumer. Personal assistant engine 74 saves the consumer considerable time and money by providing access to a comprehensive, reliable, and objective optimization model or comparative shopping service.

The personal assistant engine 74 can be made available to consumers 62-64 via computer-based online website or other electronic communication medium, e.g., wireless cell phone or other personal communication device. FIG. 4 shows an electronic communication network 80 for transmitting information between consumers 62-64, retailers 66-70, and consumer service provider 72. A consumer operating with computer 82 is connected to electronic communication network 84 by way of communication channel or link 86. Likewise, a consumer operating with a cellular telephone or other wireless communication device 88 is connected to electronic communication network 84 by way of communication channel or link 90. The electronic communication network 84 is a distributed network of interconnected routers, gateways, switches, and servers, each with a unique internet protocol (IP) address to enable communication between individual computers, cellular telephones, electronic devices, or nodes within the network. In one embodiment, electronic communication network 84 is a global, open-architecture network, commonly known as the Internet. Communication channels 86 and 90 are bi-directional and transmit data between consumer computer 82 and consumer cell phone 88 and electronic communication network 84 in a hard-wired or wireless configuration. For example, consumer computer 82 has email, texting, and Internet capability, and consumer cell phone 88 has email, texting, and Internet capability.

The electronic communication network 80 further includes consumer service provider 72 with personal assistant engine 74 in electronic communication with network 84 over communication channel or link 92. Communication channel 92 is bi-directional and transmits data between consumer service provider 72 and electronic communication network 84 in a hard-wired or wireless configuration.

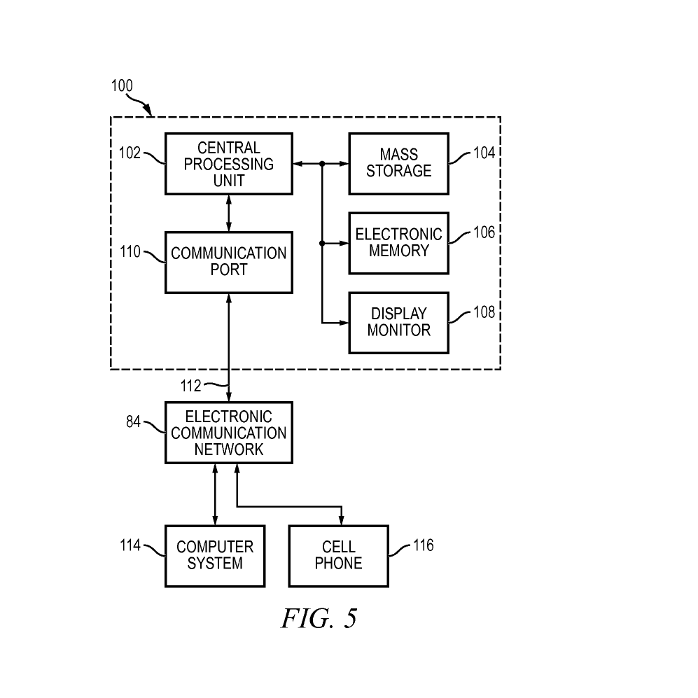

Further detail of the computer systems used in electronic communication network 80 is shown in FIG. 5 as a simplified computer system 100 for executing the software program used in the electronic communication process. Computer system 100 is a general-purpose computer including a central processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 84. Computer system or server 114 can be configured as shown for computer 100. Computer system 114 and cellular telephone 116 transmit and receive information and data over communication network 84.

Computer systems 100 and 114 can be physically located in any location with access to a modem or communication link to network 84. For example, computer 100 or 114 can be located in the consumer's home or business office. Consumer service provider 72 may use computer system 100 or 114 in its business office. Alternatively, computer 100 or 114 can be mobile and follow the user to any convenient location, e.g., remote offices, consumer locations, hotel rooms, residences, vehicles, public places, or other locales with electronic access to electronic communication network 84. The consumer can access consumer service provider 72 by mobile application operating in cell phone 116.

Each of the computers runs application software and computer programs, which can be used to display user interface screens, execute the functionality, and provide the electronic communication features as described below. The application software includes an Internet browser, local email application, word processor, spreadsheet, and the like. In one embodiment, the screens and functionality come from the application software, i.e., the electronic communication runs directly on computer system 100 or 114. Alternatively, the screens and functions are provided remotely from one or more websites on servers within electronic communication network 84.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 100 and 114 run application software for executing instructions for communication between consumer computers 82 and 88 and consumer service provider 72, gathering product information, generating consumer models or comparative shopping services, and evaluating promotional programs. The application software is an integral part of the control of purchasing decisions and other commercial activity within commerce system 60.

The electronic communication network 80 can be used for a variety of business, commercial, personal, educational, and government purposes or functions. For example, the consumer using computer 114 can communicate with consumer service provider 72 operating on computer 100, and the consumer using cellular telephone 116 can communicate with consumer service provider 72 operating on computer 100. The electronic communication network 80 is an integral part of a business, commercial, professional, educational, government, or social network involving the interaction of people, processes, and commerce.

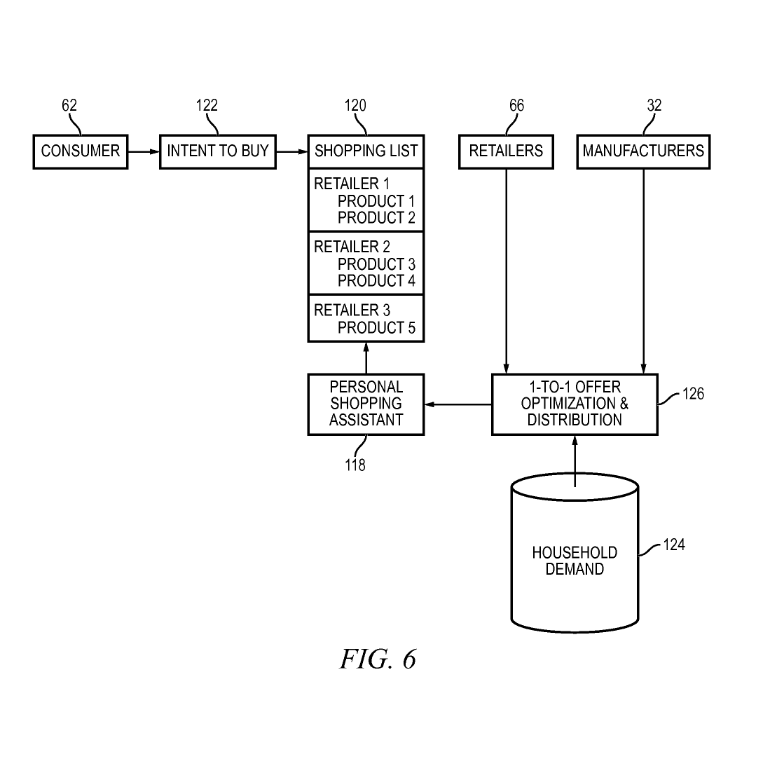

Consumer service provider 72 can assist both retailers in making additional sales and consumers in purchasing goods or services at a high value by providing a negotiation service over the electronic network. FIG. 6 shows personal shopping assistant 118, provided by consumer service provider 72, populating shopping list 120 for consumer 62. Consumer 62 indicates intent to buy 122 a type of product or attributes of a desired product to consumer service provider 72. Consumer 62 communicates intent to buy 122 to consumer service provider 72 over an electronic network using, for example, a computer or cell phone. Consumer 62 submits intent to buy 122 for multiple products or individual products in the form of shopping list 120 containing types of products for purchase. For example, consumer 62 submits intent to buy 122 by shopping list 120 generally indicating a desire to purchase milk, detergent, and deodorant. Consumer service provider 72 uses intent to buy 122 types of products or products with specific attributes to place a particular product or products on shopping list 120 in place of the generic intent to buy 122 indicated by consumer 62. Consumer service provider 72 selects products for placement on the shopping list 120 based on relative consumer value of competing products that satisfy intent to buy 122 indicated by consumer 62. Consumer service provider 72 places specific products at specific prices on the shopping list 120 in place of the more general product identifications provided by consumer 62. For example, consumer service provider 72 places one gallon of brand A milk at $3.49, 50 oz. brand B concentrated detergent at $11.99, and brand C deodorant and antiperspirant at $3.49 on the shopping list for consumer 62 to fulfil consumer desires for milk, detergent, and deodorant. Consumer service provider 72 determines which products to place on the list for specific consumer 62 based on a simulated negotiation that relies on the relative values of competing products.

Consumer service provider 72 uses discount offer information provided by retailers 66-70 and manufacturer 32, product data stored in a database, and household demand model 124 for consumer 62 to provide 1-to-1 offer optimization and distribution 126. Retailers and manufacturers provide consumer service provider 72 with discount information so that consumer service provider can offer optimized discounts to consumer 62 in order to make a sale to consumer 62. The discount information includes a maximum discount for each product and a profit share for consumer service provider 72 in the event consumer service provider 72 generates an additional sale.

Household demand model 124 allows consumer service provider 72 to place relative values on competing products. Consumer service provider 72 uses the relative values of products to establish price thresholds at which consumer 62 will purchase each competing product when the consumer indicates intent to buy 122 one or more product from a group of competing products. Consumer service provider 72 places products that are more valuable on shopping list 120 for consumer 62 when consumer service provider 72 has more accurate price threshold information for consumer 62. The relative values of different products may vary from consumer to consumer so that consumer specific models work best for determining price thresholds for individual consumer 62, with generic consumer models providing more crude thresholds. For example, TLOG data indicates that average consumers prefer brand A detergent to brand B detergent when both cost $5.00. However, consumers usually switch and purchase brand B detergent when the price drops to 80% of the price of brand A detergent, or $4.00. In other words, brand A detergent is worth 20% more to consumers on average than brand B detergent. Consumer 62 is more frugal than the average consumer and uses price as the sole determining factor in purchasing detergent. Consumer 62 will switch and purchase brand B detergent if brand B detergent is even 0.01% less expensive, or $4.99. A consumer demand model indicating a 0.01% price difference as a relative consumer value for brand B detergent is more accurate for consumer 62 than the general consumer model indicating a 20% difference as a relative consumer value.

Consumer service provider 72 automates pre-shopping for the consumer while at the same time providing an easy-to-manage promotional tool to retailers that eliminates economic risk. Consumer 62 receives a one-to-one offer from consumer service provider 72 that takes into consideration the relative value of competing products to consumer 62. Consumer service provider 72 knows which products the consumer is considering and the price thresholds at which consumer 62 will switch to competing products. Consumer service provider 72 provides the consumer with a recommended product that is in the consumer's best interest by predicting which product the consumer would select. Consumer 62 receives greater value for each purchase because the relative values have been compared to determine which product offers the best value particular to consumer 62.

Consumer service provider 72 also enables retailers to interact with consumers or consumer agents while the shopper is deciding what, and where, to purchase. Consumer service provider 72 simplifies promotion management by limiting retailer decisions to a profit share amount and a maximum discount. The retailer faces no economic risk in using consumer service provider 72 because consumer service provider limits discount offers to the maximum discount and retailer 62 decides on the profit share amount. Using the information provided by retailers, consumer service provider 72 eliminates the risk that retailer will over discount products by evaluating the relative value of products to consumer 62 and adjusting the price of the products accordingly. The retailer can make the ideal offer to consumer 62, at the price where consumer 62 will switch to the retailer's product, at the exact moment consumer 62 is deciding which product to purchase.

For example, two coffee companies offer competing coffee products. The first company offers a first coffee product for $10.00. Consumer 62 purchases the first coffee product on most trips to the grocery store without comparing to other coffee products, including the second coffee product offered by the second retailer, because the time spent analyzing relative value is not worth the increased value to consumer 62. The second retailer offers the second coffee product for $9.00 and authorizes consumer service provider 72 to offer a discount of $3.00 on the second coffee product with a profit share of 50%. In other words, the second retailer is willing to sell the second coffee product to consumer 62 for $6.00. The consumer would purchase the second coffee product if the price were $8.00 or less, but the retailer does not know that and cannot target consumer 62 with a personalized $1.00 discount. Consumer service provider 72 offers consumer 62 a discount of $1.00 to bring the price of the second coffee product to $8.00, the exact point at which consumer 62 would switch to the second coffee product. Consumer 62 purchases the second coffee product at $8.00 instead of the first coffee product and receives a better value than if consumer 62 purchased the first coffee product at $10.00. Consumer 62 receives the greater value without having to compare the first and second coffee products on his own. The retailer makes an additional sale at $8.00 without over discounting the second coffee product to $6.00, resulting in an additional $2.00 in incremental profit over the maximum discount the retailer was willing to offer. The retailer made the additional sale and avoided the economic risk of over discounting by providing a maximum discount and a profit share to consumer service provider 72. Consumer service provider 72 receives 50% of the incremental profit of $2.00, or $1.00, as a share in the incremental profit of the retailer. Thus, the discount offer from consumer service provider aligns the interests of the consumer, the retailer, and the consumer service provider.

The consumer service provider controls the commerce system by comparing options under consideration and predicting the most valuable option for consumer 62 while limiting economic risk of the retailer. Consumer service provider 72 creates competition for the offer to consumer 62 where only one offer is made to a shopper to fill a particular need or desire. Consumer service provider aligns the goals of the retailer, consumer, and itself by identifying a high-value product for the consumer without the decision stress of evaluating every option, providing the retailer an additional sale without over-discounting the product, and sharing in the increased revenue of the retailer. Thus, each member of the commerce system that is involved in the purchasing decision benefits from the personal discount offers.

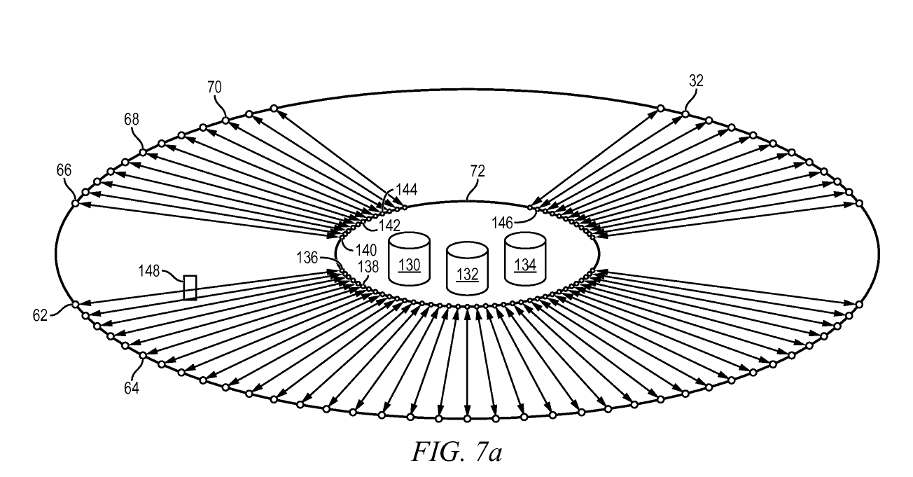

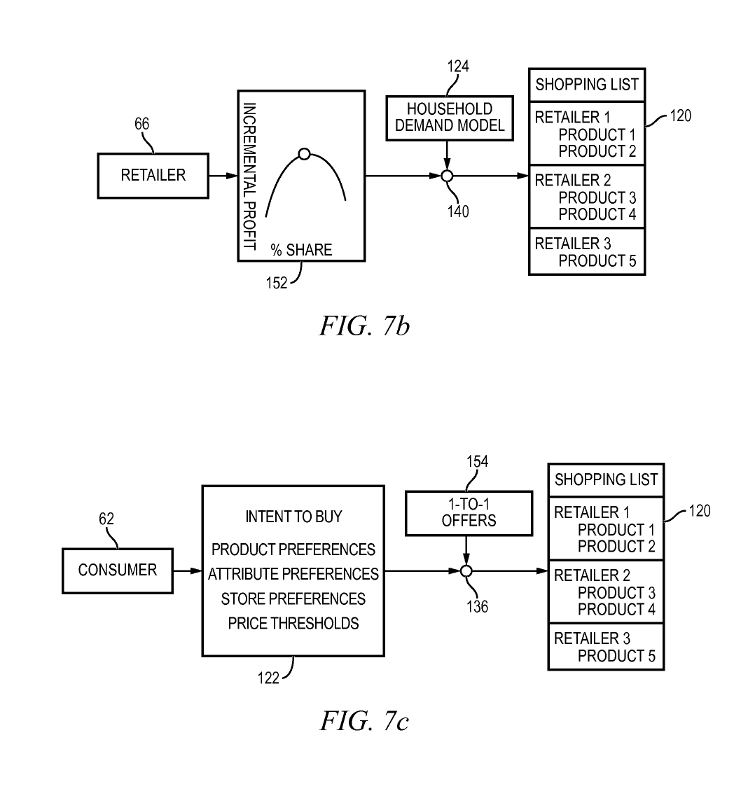

Consumer service provider 72 serves as a go between for consumers and retailers or manufacturers selling goods. Consumer service provider 72 provides agent-based personalized deal negotiation for consumers 62-64, retailers 66-70, and manufacturer 32, as shown in FIG. 7a. FIG. 7b provides further detail on the interaction between consumer service provider and retailers 66-70. Retailers and manufacturers decide how much incremental profit to share with consumer service provider 72 and authorize retailer agent 140 to offer a maximum discount. Incremental profits depend on the maximum discount authorized by retailer 66 for a product so that retailer 66 has no economic risk in making an offer. Cumulative incremental profit and share percentage have relationship 152 that allows retailers 66-70 to maximize the cumulative incremental profit by selecting a share percentage that results in many offers to consumer and retains some of the incremental profit for retailers 66-70. Retailer agent 140 uses household demand model 124, based on consumer 62, to generate automated and optimized one-to-one offers for products. Consumer service provider 72 places products on shopping list 120 if consumer service provider selects the one-to-one offer for the product.

Consumers 62-64 submit intent-to-buy information 122 to consumer service provider 72 to receive an optimized shopping list 120 back from consumer service provider 72 containing personalized, one-to-one offers. As shown in FIG. 7c, intent-to-buy information 122 includes product preferences, attribute preferences, store preferences, and/or price thresholds. Intent-to-buy information 122 is submitted to consumer agent 136. Consumer service provider 72 runs consumer agent 136 using the intent-to-buy information for automated optimized shopping list generation. An optimized shopping list contains one-to-one offer 154 to purchase discounted products that fulfill the intent to buy desires of consumer 62. Consumer agent 136 negotiates with retailer agents to receive the one-to-one offer 154 with the most value to consumer 62. Consumer service provider 72 uses discounts authorized by retailers and manufacturers to provide the one-to-one offer or individualized discount offers 154 to consumer 62.

Returning to FIG. 7a, consumer service provider 72 creates the one-to-one offers using product information databases as well as parameters submitted by retailers 66-70 and manufacturer 32. Consumer service provider maintains a retailer database 130 containing retailer information including retailer categories, product linking, and product attributes. The database allows consumer service provider 72 to make the connection between the more general intent-to-buy information, submitted by consumers, and the products offered for sale that satisfy the consumer intent to buy. Retailers and products stored in the database have associated attributes that can match or fulfil consumer needs. For example, product attributes can be product-specific attributes, diet/health/nutrient related product attributes, lifestyle related product attributes, environment related product attributes, allergen related product attributes, and social/society related product attributes. Product-specific attributes could also include brand, ingredients, size, price, freshness, warranty, and the like. Consumer service provider 72 also maintains pricing database 132 including local online and in-store pricing and availability. The database enables consumer service provider 72 to identify retailers doing business in the area of consumer 62 and the pricing of various products in that area. Consumer service provider 72 also maintains a database 134 of intent to buy and predictive household demand models. The intent-to-buy data submitted by consumers is stored in the intent-to-buy database. Predictive household demand models for consumer 62 are also stored in the intent-to-buy database. Consumer service provider 72 can maintain separate databases 130-134 or maintain a single database containing the tables and records from databases 130-134.

Offer gate 148 limits the number of offers consumer 62 receives for each product consumer 62 intends to buy. Offer gate 148 can be configured to allow one or more offers to go to each consumer. If the offer gate is set to one offer then consumer 62 has no control over the product initially placed in the shopping list. If offer gate 148 is configured to allow more than one offer to go to consumer 62 then consumer 62 can select between the two offers and elect to place one or more of the offered products in shopping list 120.

Consumer service provider 72 simultaneously assists retailers and consumers by controlling purchase decisions within the commerce system. The consumer service provider automates pre-shopping for the consumer while at the same time providing an easy-to-manage promotion system to retailers that eliminates economic risk. Consumer 62 receives a one-to-one offer that takes into consideration the relative value of products to consumer 62. Consumer service provider 72 knows which products the consumer is considering and where the price thresholds for switching between products occur. Consumer service provider 72 uses the consumer information to create competition between retailers to provide one of a limited number of offers to consumer 62. When the consumer receives only one product offer, for example, retailers must compete with one another to have their offer selected. Consumer service provider 72 provides retailer with a promotion-management system requiring a retailer to decide only on a profit share amount and maximum discount. The retailer easily manages the discount promotions with minimal investment. The retailer reduces economic risk when over discounting is eliminated by the discounts offered by consumer service provider. Consumer service provider controls the commerce system by comparing options under consideration and predicting the most valuable option for consumer 62 while limiting economic risk of the retailer. As a result, the consumer gets the most valuable product available at an optimal discount with reduced decision stress. The retailer makes an additional sale at an optimum price to increase sales revenue. The consumer service provider shares in the increased sales revenue of the retailer. Thus, each member of the commerce system involved in the purchasing decision benefits from the personal discount offers.

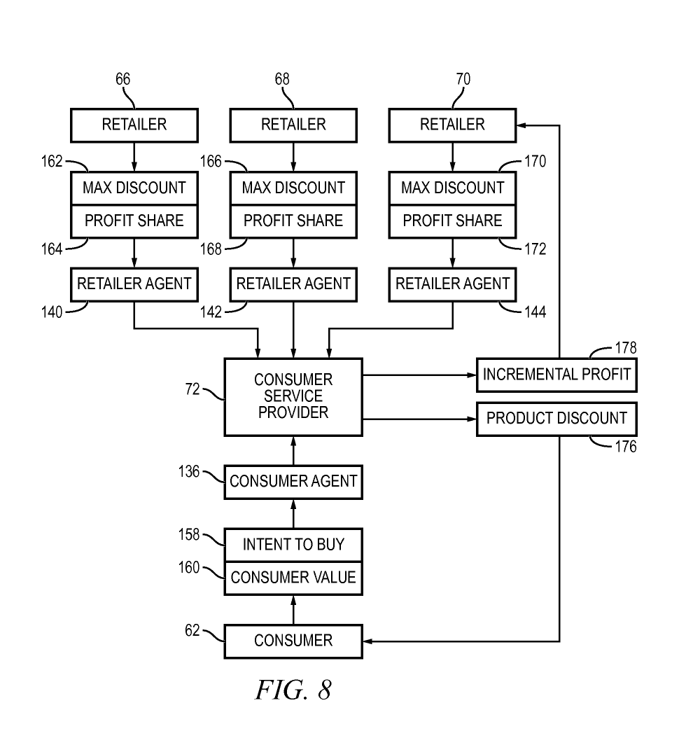

Retailers, consumers, and manufacturers communicate indirectly over the electronic network to negotiate, as shown in FIG. 8, through consumer service provider. Consumer service provider 72 uses information provided by consumer 62 including desired products or intent to buy 158 and consumer values 160 submitted by consumer 62 to consumer agent 136. Consumer 62 manages the consumer values 160 and intent-to-buy 158 information by providing personal product preferences, store preferences, attribute preferences, and price switching thresholds. Alternatively, consumer 62 provides consumer values simply by shopping at retailers that submit TLOG data detailing the purchase history of consumer 62. Personal product preferences for consumer 62 can be provided directly by consumer 62 or derived from past product purchases of consumer 62, preferences of other consumers, or from particular product attributes identified by consumer 62. Product preferences signal that consumer 62 is seeking to buy a certain product or type of product. Retailer preferences indicate that consumer 62 prefers to shop at particular retailers. Attribute preferences indicate that consumer 62 prefers products with certain attributes, such as certain flavors, ingredients, or manufacturing processes. For example, consumer 62 indicates to consumer agent 136 that consumer 62 desires to purchase milk. The product preference for milk informs consumer agent 136 that consumer 62 wants to purchase milk. The price thresholds indicate a relative value between two or more competing products. When a substitute product is offered at a price at or below the price threshold relative to a preferred product, consumer 62 is willing to purchase the substitute product instead of the preferred product.

For example, consumer 62 indicates that one-half gallon of brand A milk is an acceptable product. Consumer 62 also indicates that consumer 62 would be willing to pay 30% more for one gallon of brand B milk than for one-half gallon of brand A milk. The trade-up value for consumer 62 to replace one-half gallon of brand A milk with one gallon of brand B milk is 30%. Consumer 62 further indicates a willingness to pay 20% more for one gallon of brand A milk than for one gallon of brand B milk. The trade-up value for consumer 62 to replace one gallon of brand B milk with one gallon of brand A milk is 20%. The trade-up value to replace one-half gallon of brand A milk with one gallon of brand A milk includes the 30% value increase from one-half gallon of brand A to one gallon of brand B as well as the 20% increase from one gallon of brand B to one gallon of brand A milk. The relative values of the different milk products to consumer 62 correspond with the relative percentages of relevant price thresholds for consumer 62 seeking to purchase milk.

Consumer 62 provides similar information to consumer service provider 72 to indicate the relative value of shopping at different retailers. For example, consumer 62 shops at local retailer 66. Consumer 62 indicates willingness to switch to retailer 68 for a single shopping trip provided retailer 68 is 10% less expensive or provides 10% greater shopper value for the entire shopping trip than retailer 66 does to satisfy the same intent-to-buy information. The trade-up value for Consumer 62 to switch from retailer 68 to retailer 66 is 10%. Consumer 62 further indicates willingness to shop at retailer 70 if retailer 70 is 15% less expensive, or provides 15% greater shopper value, for the same products than retailer 68. The trade up value for consumer 62 to shop at retailer 68 is 15%. The trade up value for consumer 62 to shop at retailer 66 instead of retailer 70 includes the 15% to switch from retailer 70 to retailer 68 and the 10% to switch from retailer 68 to retailer 66. The trade-up values indicate the price threshold at which a consumer is willing to change to an alternative product or retailer.

Consumer 62 can also provide thresholds in terms of product cost, dollars per serving or use, or any other format that captures switching thresholds or the relative value of competing products and retailers. Once the consumer indicates the products that the consumer is shopping for on a particular trip, price thresholds for the product, or which retailer the consumer intends to use, the consumer agent 136 can negotiate the best subjective value for consumer 62 on products that satisfy the intent to buy of consumer 62. Consumer agent 136 provides the best results when provided with complete and accurate information. However, consumer agent 136 can operate and locate a suggested product or shopping list even if consumer 62 omits information such as price thresholds, preferred retailers, or even preferred products by relying on generic thresholds, retailer preferences, and product preferences instead of consumer specific information. Generic consumer information models the desires of the average consumer of consumers with similar purchasing history to consumer 62.

Consumer service provider creates retailer agent 140 for retailer 66, retailer agent 142 for retailer 68, and retailer agent 144 for retailer 70. Retailer 66 provides information to retailer agent 140 including maximum discount 162 and a profit sharing amount 164. Retailer 68 provides information to retailer agent 142 including maximum discount 166 and a profit sharing amount 168. Retailer 70 provides information to retailer agent 144 including maximum discount 170 and a profit sharing amount 172. The maximum discount or budget submitted by retailer 66 indicates a dollar amount that retailer 66 is willing to discount for a particular product. For example, retailer 66 selling milk can provide a gallon of milk to consumer 62 at a cost of $2.00 to retailer 66. The selling price for a gallon of brand A milk is regularly $3.50. Retailer 66 submits $1.50 as the maximum discount because $1.50 represents the maximum discount applicable to the milk before retailer 66 experiences a loss, making the price of milk with the maximum discount equal to the cost of providing the product. Retailer 66 eliminates economic risk by submitting a maximum discount less than or equal to the profit margin on a particular product. By submitting $1.50 as the maximum discount to retailer agent 140, retailer 66 is authorizing consumer service provider 72 to present discounts on one gallon of brand A milk for up to $1.50 to interested consumers, potentially bringing the cost to purchase the milk down to $2.00. However, retailer agent 140 will not offer the maximum discount in every situation. Retailer agent 140 negotiates with consumer agent 136 through consumer service provider 72 to find the minimum discount required evoke a positive purchasing decision from consumer 62.

The profit sharing amounts provided by retailers 66-70 represent the amount retailers 66-70 are willing to pay to consumer service provider 72 to have their discount offer or coupon delivered to consumer 62. Retailers and manufacturers decide how much incremental profit to share with consumer service provider 72. Each time a retailer coupon is delivered to consumer 62 and consumer 62 purchases the corresponding product an incremental profit results. The incremental profit is the amount of profit retailer 66 gains through the sale of the discounted product to consumer 62, who would have purchased a competing product absent the personalized discount. Incremental profit is generally equal to the difference between the individualized discount offered to a consumer and the maximum authorized discount. The profit sharing amount can be provided in terms of a percentage or a currency amount. For example, retailer 66 submits a profit sharing percentage of 10%. Retailer agent 140 negotiates with consumer agent 136 and provides the greatest value to consumer 62 by providing a discount of $1.00 for one gallon of brand A milk. The $1.00 discount is $0.50 less than the maximum discount of $1.50, reflecting an incremental profit of $0.50. Consumer 62 receives the discount offer and retailer 66 gains $0.45 of the incremental profit (90%) and pays consumer service provider $0.05 (10%).

Consumer agent 136 and retailer agents 140-144 negotiate to find a discounted price at which one or more products from retailers 66-70 are best values satisfying a consumer intent to buy indirectly, through consumer service provider 72. The negotiation results in product discounts 176 for consumer 62 and an incremental profit 178 for each retailer that sells one of the discounted products to consumer 62. For example, consumer service provider 72 is configured to provide one product in response to a consumer product preference indicating that the consumer would like to purchase laundry detergent. Consumer service provider 72 selects the product that will evoke a positive purchasing decision at a price authorized by the retailer selling the product. In many instances, more than one product would evoke a positive purchasing decision at a discount within the amount authorized by retailers 66-70.

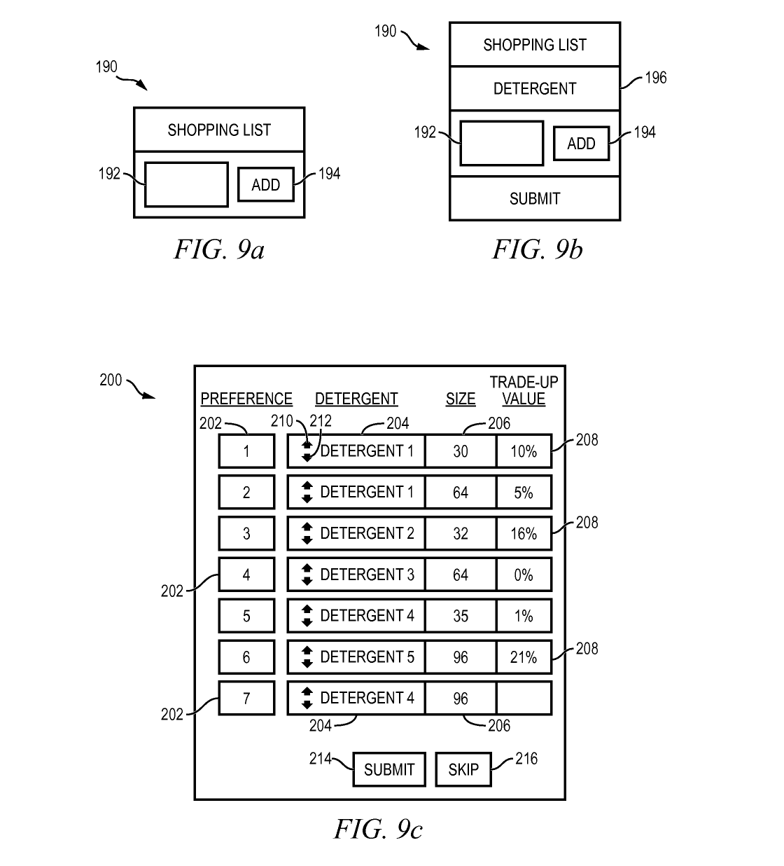

Consumer 62 submits desired product information for consumer agent 136 using interface 190 of FIGS. 9a-9b. Consumer 62 inserts a desired product into field 192, for example, by typing, selecting from a drop down menu, or browsing product categories. Once a desired product, such as detergent, is indicated in field 192 consumer 62 presses add button 194 to add the selection to the shopping list. The added selection appears as an entry in field 196 of interface 190. Consumer 62 can then continue to add additional products using field 192 and add button 194 until the shopping list includes all the desired products for a shopping trip. Once consumer 62 is satisfied with the shopping list, consumer 62 presses submit button 198 to send the shopping list to consumer service provider 72.

Consumer service provider 72 uses consumer values 160 to determine relative value for competing products satisfying the desired products submitted through interface 190. Consumer values 160 can be stored from a past consumer submission, derived from TLOG data, or provided by consumer 62. Past consumer values 160 can be displayed for consumer 62 for updates to ensure the consumer values remain updated. Consumer 62 is presented with interface 200 to submit or modify consumer values 160 in FIG. 9c. A list of relevant products is presented with a preference 202 for each product 204. Consumer 62 can add or remove products 204 from consideration. Products 204 have a size 206 and a trade-up value 208. The trade-up value reflects the value to consumer 62 of a particular product relative to next product in terms of preference. Consumer 62 arranges the products in interface 200 by moving competing products up and down the list until the products 204 or in the desired order of preference. Consumer 62 enters trade-up values in blocks 208 corresponding to each product. For example, consumer 62 finds that detergent 5 in the 96-load size is 21% more valuable than detergent 4 in the 96-load size, so consumer 62 enters 21% into block 208 for the detergent product with preference 6. Consumer 62 enters the trade up values for the detergent products 204 with preference 202 of 1-5 as 10%, 5%, 16%, 0%, and 40%, respectively. Consumer service provider 72 presents interface 200 for each product on the shopping list submitted by consumer 62. Consumer 62 presses submit button 214 to submit the consumer values entered into interface 200 when consumer 62 is satisfied with the value list. Alternatively, consumer 62 can press skip button 216 to proceed without submitting or modifying personal consumer values. Consumer service provider 72 uses general consumer values, or past values submitted by consumer 62 if available, when consumer 62 elects to skip submitting consumer values.

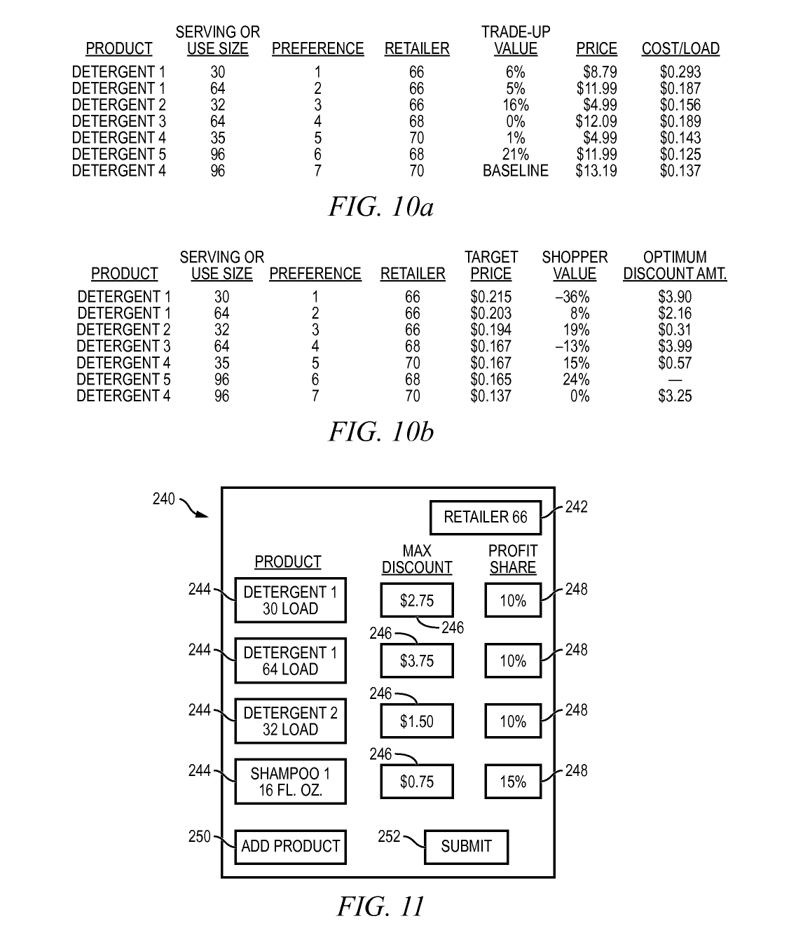

Consumer service provider provides consumer agents to determine which product is best for a consumer based on price thresholds. Consumer 62 has a consideration set including products under consideration for purchase and rankings for the products. In a new consideration set, before determining product rankings, all products in the consideration set having the same default ranking. The price thresholds and product rankings can be stored with a consideration set in an electronic storage medium for later access. Consumer agent uses consideration set to negotiate discounted prices with retailer agents. For example, consumer price thresholds for detergent, shown in FIG. 10a, result from consumer submissions in FIGS. 9a-9c. Consumer 62 can submit price thresholds by ranking the products in a category in order of desirability to consumer 62 and assigning value percentages reflecting the value difference between each product. For example, consumer 62 identifies seven detergent products that consumer 62 would consider purchasing at different price thresholds. Consumer lists the seven products in order of preference, with the most desirable product ranked or listed first. The seven detergent products that consumer 62 is considering for purchase form a consideration set for consumer 62 comprising the detergent products that consumer 62 would consider purchasing.

A consideration set can be created based on consumer input. For example, consumer 62 can submit a list of products to consumer service provider. Alternatively, consumer 62 can form a consideration set by selecting desired products or removing products that are not under consideration from a list of possible products. For example, consumer 62 is presented with a list of one hundred detergent products including detergent A through detergent Z. Consumer selects detergents A-E as the consideration set of detergent products the consumer would consider purchasing. Detergents F-Z are omitted from the consideration set. When consumer service provider determines which detergent product to place on the shopping list for consumer 62, consumer service provider 72 can limit the products under consideration to detergent products A-E. Consideration sets can also be created using product attributes or consumer preferences. For example, consumer 62 indicates that consumer 62 will only purchase organic food products. Consumer service provider 72 only considers organic food products for placement on a shopping list for consumer 62 when consumer 62 indicates an intent to purchase a food product. Consideration sets can also be determined from TLOG data of consumer 62 or similar consumers. For example, TLOG data indicates that consumer 62 has purchased detergent products A-E in the past. Consumer service provider includes detergents A-E in the consideration set for consumer 62 when consumer 62 is seeking to purchase a laundry detergent. Consumer service provider 72 saves consideration sets for future use when consumer 62 desires or needs a product and indicates an intent to purchase a product from the consideration set.

Returning to FIG. 9c, consumer 62 creates a consideration set listing the 96 load size of detergent 4 from retailer 70 as the least desirable detergent that consumer 62 is considering. Consumer 62 lists the 96-load size of detergent 5 from retailer 68 as sixth most preferable option and indicates that the sixth detergent is 21% more valuable to consumer 62 than the seventh detergent. Consumer 62 lists the 35-load size of detergent 4 from retailer 70 as fifth most preferable option and indicates that an upgrade from sixth most preferable option to the fifth most preferable option is worth 1% more to consumer 62. Consumer 62 lists the 64-load size of detergent 3 from retailer 68 as fourth most preferable option and indicates that an upgrade from fifth most preferable option to the fourth most preferable option is worth 0% to consumer 62. Consumer 62 lists the 32-load size of detergent 2 from retailer 66 as third most preferable option and indicates that an upgrade from the fourth most preferable option to the third most preferable option is worth 16% to consumer 62. Consumer 62 lists the 64-load size of detergent 1 from retailer 66 as second most preferable option and indicates that an upgrade from the third most preferable option to the second most preferable option is worth 5% to consumer 62. Finally, consumer 62 lists the 30-load size of detergent 1 from retailer 66 as most preferable option and indicates that an upgrade from the second most preferable option to the most preferable option is worth 6% to consumer 62.

Consumer service provider 72 uses the prices stored in a pricing database 132 for local or online retailers to locate the best current prices for the seven listed detergent products. Consumer service provider looks up the price for the potential detergent products. The price for each detergent can be a nationwide average price, a local average price, the price of the product at consumer's preferred retailer, the highest price, or any other indicator of the price of the detergents without a one-to-one discount offer. In FIG. 10a, consumer service provider looks up the price of the detergents listed by consumer 62 in interface 200 using database 132.

Consumer service provider 72 calculates a price per use for products to compare the value and cost of products per use by dividing the price of the product by the number of suggested uses or servings. For example, consumer service provider divides the price of each detergent product that consumer 62 may be interested in purchasing by the number of loads the manufacturer recommends using the detergent to calculate the cost per use. Consumer service provider 72 looks up the price of 30-load size of detergent 1 from retailer 66 and finds that the local price is $8.79. Since the 30-load size of detergent 1 can be used for 30 loads of laundry, consumer service provider divides $8.79 by 30 to calculate the current cost per load of the 30-load size of detergent 1 to consumer 62 as $0.29 per load. Consumer service provider divides the $11.99 price of the 64-load size of detergent 1 by 64 to determine that the cost per load of the 64-load size of detergent 1 to consumer 62 is $0.19 per load. Consumer service provider divides the $4.99 price of the 32-load size of detergent 2 by 32 to determine that the cost per load of the 32-load size of detergent 2 to consumer 62 is $0.16 per load. Consumer service provider divides the $12.09 price of the 64-load size of detergent 3 by 64 to determine that the cost per load of the 64-load size of detergent 3 to consumer 62 is $0.19 per load. Consumer service provider divides the $4.99 price of the 35-load size of detergent 4 by 35 to determine that the cost per load of the 35-load size of detergent 4 to consumer 62 is $0.14 per load. Consumer service provider divides the $11.99 price of the 96-load size of detergent 5 by 96 to determine that the cost per load of the 96-load size of detergent 5 to consumer 62 is $0.12 per load. Consumer service provider divides the $13.19 price of the 96-load size of detergent 4 by 96 to determine that the cost per load of the 96-load size of detergent 4 to consumer 62 is $0.13 per load.

Consumer service provider 72 uses the relative value of products specific to consumer 62, provided as consumer value 160, to project a target price. The target price for each product is the price threshold at which consumer 62 will likely purchase each product projected based on current pricing of a baseline product and subjective consumer values. Consumer service provider 72 selects a baseline value to start from by selecting the product with the lowest preference, although any product on the list can serve as the baseline product. Consumer service provider 72 selects the per-load price of the product with the lowest preference as the baseline value to project a target price. From the baseline value consumer service provider 72 projects the target price of each detergent by increasing or decreasing the baseline value by the trade-up value for the products with adjacent preference values. For example, consumer service provider 72 calculates the target price for the product with preference of 6 using the baseline per-load price of the product with preference of 7 by increasing the baseline value by the trade up value. Consumer service provider 72 then calculates the target price of each subsequent product by multiplying the target price of the product with the next lower preference by the trade-up value.

For example, in FIG. 10b, consumer service provider 72 selects the price per load of $0.137 of the 96-load size of detergent 4, with a preference of 7, as a baseline value. Consumer service provider 72 increases the baseline target price, the price of the 96-load size of detergent 4 with preference 7, by the consumer-specific trade-up value of 21% for the detergent with preference 6 to calculate the target price for the 96-load size of detergent 5 with preference 6. The target price of the 96-load size of detergent 5 with preference 6 is equal to $0.137 per load increased by 21%, totaling $0.165.

Consumer service provider 72 increases the target price of the 96-load size of detergent 5, with preference 6, by the consumer-specific trade-up value of 1% for the detergent with preference 5 to calculate the target price for the 35-load size of detergent 4 with preference 5. The target price of the 35-load size of detergent 4 with preference 5 is equal to $0.16 per load multiplied by 1.01, a 1% increase, totaling $0.167.

Consumer service provider 72 increases the target price of the 35-load size of detergent 4 with preference 5, by the consumer-specific trade-up value of 0% for the detergent with preference 4 to calculate the target price for the 64-load size of detergent 3 with preference 4. The target price of the 64-load size of detergent 3, with preference 4, is equal to $0.167 per load multiplied by 1.00, a 0% increase, totaling $0.167.

Consumer service provider 72 increases the target price of the 64-load size of detergent 3 by the consumer-specific trade-up value of 16% for the detergent with preference 3 to calculate the target price for the 32-load size of detergent 2 with preference 3. The target price of the 32-load size of detergent 2 with preference 3 is equal to $0.167 per load multiplied by 1.16, a 16% increase, totaling $0.194.

Consumer service provider 72 increases the target price of the 32-load size of detergent 2, with preference 3, by the consumer-specific trade-up value of 5% for the detergent with preference 2 to calculate the target price for the 64-load size of detergent 1 with preference 2. The target price of the 64-load size of detergent 1 with preference 2 is equal to $0.194 per load multiplied by 1.05, a 5% increase, totaling $0.203.

Consumer service provider 72 increases the target price of the 64-load size of detergent 1 with preference 2, by the consumer-specific trade-up value of 6% for the detergent with preference 1 to calculate the target price for the 30-load size of detergent 1 with preference 1. The target price of the 30-load size of detergent 1 with preference 1 is equal to $0.203 per load multiplied by 1.06, a 6% increase, totaling $0.215.

The target price for each detergent represents the price at which each detergent becomes more valuable to consumer 62 than the detergents with lower preferences. The target price for a desired product can also be determined from the baseline product value by adding up the intermediate trade-up percentages between the desired product and the baseline product and increasing the baseline value by the resulting sum. For example, the 64-load size of detergent 3, with a preference of 4, can be calculated by adding the intermediate trade-up percentages, 21, 1, and 0, and increasing the baseline value of $0.137 per load by the sum of 22%. The result is the same target price of $0.167 as calculated using the incremental method outlined above.

Consumer service provider 72 compares the actual price per load of each detergent to the target price per load for each detergent to find the shopper value of each product at the current price. The shopper value is a percentage of target price, calculated by finding the difference between the target price per load and the current cost per load then dividing the difference by the target price. When the cost per load is less than the target price for a product, the shopper value is positive. When the cost per load of a product is greater than the target price, the shopper value of the product is negative.

Consumer service provider 72 then identifies the product having the greatest value to consumer 62 at the current price by selecting the highest shopper value. Consumer service provider uses the highest shopper value as a reference point to calculate an optimum discount on competing products. The price point at which each product has a value matching the greatest shopper value is the price point at which consumers will switch from the product having the greatest value to the each competing product, or the switching threshold. In FIG. 10b, the 96-load size of detergent 5 has the greatest shopper value because the target price exceeds the current price by 24%, a greater percentage than any other detergent. Consumer 62 will switch from detergent 5 in the 96-load size to a competing detergent only when the shopper value of the competing detergent is 24% or greater. In order to increase the shopper value of competing detergents, consumer service provider offers optimized, one-to-one discounts to the current price. By reducing the current price of a competing product, consumer service provider 72 increases the shopper value of the competing product to the switching threshold. Optimized discounts can take into consideration the discount information submitted by retailers 66-70, such as maximum discount and profit share, to determine whether to offer the optimized discount for each product to consumer 62.

Consumer service provider 72 calculates the optimum personalized discount for consumer 62 by determining the discount required to increase the shopper value of each detergent to match or exceed the highest shopper value before discount. The discount, if applied, is just enough to reach the switching threshold identified for consumer 62. The optimum discount percentage is determined by subtracting the shopper value for each product from the highest shopper value to find the required discount percentage. For example, consumer service provider 72 calculates the optimum personalized discount for each detergent product considered by consumer, as shown in FIG. 10b. Detergent 4 in the 96-load size has a shopper value of 0% and the highest shopper value of competing detergent products is 24%. The difference between the shopper values is 24%. The optimum discount for detergent 4 in the 96-load size is 24% of the target price, $0.137 per load, multiplied by the number of loads, 96, or $3.25. Detergent 5 in the 96-load size is the detergent with the highest shopper value before discount of 24% with an optimum discount of 0% since consumer 62 would select Detergent 5 in the 96-load size at the available prices before discount.

The difference between the 15% shopper value of the 35-load size of detergent 4 and the maximum shopper value of 24% is 10%. Consumer service provider 72 finds the optimum discount for detergent 4 in the 35-load size is 10% of the target price of $0.167 per load multiplied by 35 loads, or $0.57. The difference between the −13% shopper value of the 64-load size of detergent 3 and the maximum shopper value of 24% is 37%. The optimum discount for detergent 3 in the 64-load size is 37% of the target price per load of $0.167 multiplied by 64 loads, or $3.99. The difference between the 19% shopper value of the 32-load size of detergent 2 and the maximum shopper value of 24% is 5%. The optimum discount for detergent 2 in the 32-load size is 5% of the target price per load of $0.194, or $0.31. The difference between the 8% shopper value of the 64-load size of detergent 1 and the maximum shopper value of 24% is 16%. The optimum discount for detergent 2 in the 64-load size is 16% of the target price per load of $0.203, or $2.16. The difference between the −36% shopper value of the 30-load size of detergent 1 and the maximum shopper value of 24% is 60%. The optimum discount for detergent 1 in the 30-load size is 60% of the target price per load of $0.215, or $3.90.

Consumer agents 136-138 submit availability of a higher-value alternative as leverage to receive a price on a competing product that presents at least as good a value as the alternative product with the highest subjective value to consumer 62. Retailer agents 140-144 accept a maximum discount or budget from retailers 66-70 for use in determining whether the optimized personal discount is available to offer consumer 62. If the optimized personal discount is greater than the maximum discount authorized by retailers 66-70 or manufacturer 32, then consumer service provider 72 does not offer the optimized discount.

Retailers 66-70 submit maximum discount and profit sharing information to retailer agents 140-144 using interface 240 of FIG. 11. Retailer 66 logs into retailer agent 140 with the active retailer profile shown in profile block 242. Retailer 66 enters products offered by retailer 66 into product field 244. Retailer 66 enters products using UPCs, SKUs, text entry, list selection, TLOG data, or product browsing. Consumer service provider 72 can also present retailer with a list of products based on TLOG data from retailer 66 identifying specific products sold by retailer 66. For each product indicated in fields 244, retailer 66 provides a maximum discount 246 and a profit share 248. Maximum discount 246 is the maximum price reduction authorized by retailer 66 for the corresponding product in field 244. The maximum discount can also be submitted as a lowest price for a product. For example, retailer 66 submits a maximum discount of $1.00 for a $5.00 milk product, resulting in a minimum price of $4.00. Retailer 66 could also submit the minimum price of $4.00 for the milk product rather than the maximum discount of $1.00 by selecting an option to change the format of maximum discount 246 to accept a minimum price instead.

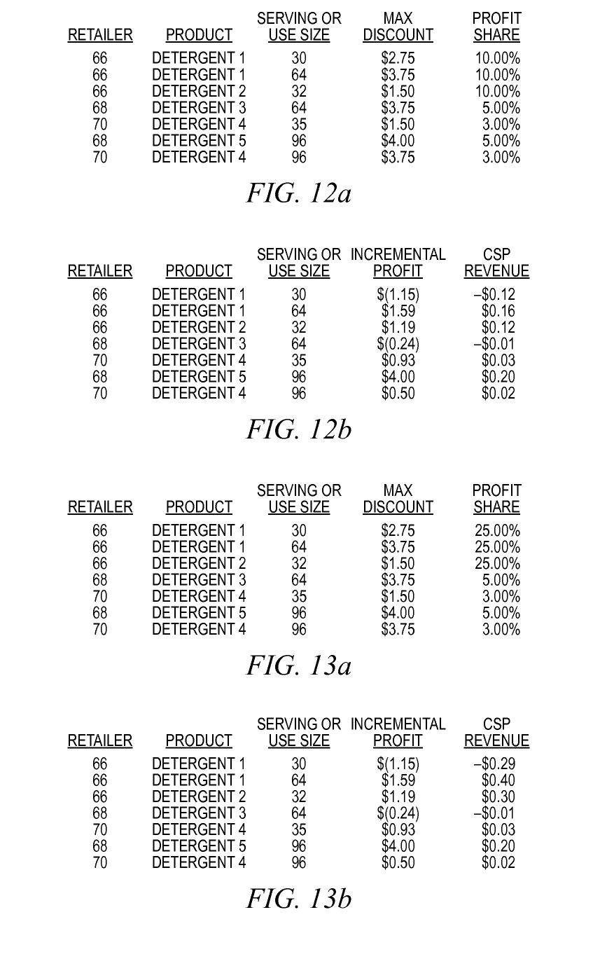

In FIG. 12, retailer agents 140-144 have a maximum discount provided by the corresponding retailers 66-70 using interface 240. Retailer 66 has set the maximum discounts for 30-load size of detergent 1 at $2.75, 64-load size of detergent 1 at $3.75, and 32-load size of detergent 2 at $1.50. Retailer 68 has set the maximum discount for 64-load size of detergent 3 at $3.75. Retailer 70 has set the maximum discount for the 35-load size of detergent 4 at $1.50 and for the 96-load size at $3.75. Retailer 68 has set the maximum discount for the 96-load size of detergent 5 at $4.00.

Competing retailers and manufacturers want to increase the maximum discount until the maximum discounted price is equal to the cost of providing the product. A maximum discount equal to the cost of providing a product ensures that no economic risk exists for the retailer submitting the maximum discount. In some instances, a maximum discount greater than the cost of providing a product may be used. A retailer may sell a product with a high affinity to another product at a loss. For example, a retailer will sell a flashlight at a slight loss if the consumer is also likely to purchase batteries from the retailer at a price sufficient to make up for the loss on the flashlight. A retailer may also use a maximum discount greater than the cost of providing a product in order to use the product as a loss leader, i.e., to get a consumer in the door when the consumer is likely to purchase more than just the one product. For example, a retailer offers a maximum discount on milk that causes any milk purchased at the maximum discount to result in a loss because the retailer expects consumers who purchase the milk to make other purchases from the retailer sufficient to overcome the loss, such as the remaining groceries on the consumer's shopping list. The retailer that makes a sale at the optimized discount price for a product gains an incremental profit equal to the difference between the maximum discount and the optimized discount.

Consumer service provider 72 provides a limited number of discount offers for every product a consumer intends to buy. For example, if a consumer intends to purchase two detergent products, or consumer 62 would like to select one of the two best product values, then the consumer will receive a maximum of two discount offers from consumer service provider. Either consumer 62 or consumer service provider 72 sets the number of offers to present to consumer 62. Continuing from the example in FIG. 10a, consumer service provider is set to select one optimized discount offer for each product a consumer intends to purchase. Consumer service provider 72 evaluates the potential optimized discounts offered by retailer agents and selects the optimized discount that provides consumer service provider 72 with the greatest overall revenue for presentation to consumer 62. The incremental profit share amount can be set separately for each product, or once for all products offered by a retailer 66. Continuing the example in FIG. 12b, retailer 66 has set the incremental profit share at 10%, indicating that consumer service provider will receive 10% of any incremental profit generated by an optimized discount offer for any products offered by retailer 66.

Interests of retailer 66 align with interests of consumer service provider 72 because the consumer service provider receives a percentage of any incremental profit. Retailers submit the percentage of incremental profit shared with consumer service provider. Interests of consumer 62 align with interests of consumer service provider 72 because consumer service provider seeks to deliver a product with high value to consumer 62 so that consumer 62 continues to use consumer service provider 72. The profit share for consumer service provider 72 is equal to the share percentage submitted by the retailer multiplied by the incremental profit that would result from a sale of the retailer's product with the optimized discount. Consumer service provider 72 allocates the profit share

For example, FIG. 12b shows the incremental profit from a consumer purchase of a product based on the difference between the maximum discount authorized and the optimized discount applied to the product. The 30-load size of detergent 1, from retailer 66, has a maximum discount of $2.75, shown in FIG. 12a, and an optimized discount of $3.90, shown in FIG. 10b. The optimum discount exceeds the maximum discount, so the incremental profit for the offer would be negative, as shown in FIG. 12b. The product with the highest value should have an incremental profit greater than or equal to zero, so consumer service provider 72 can usually avoid selecting a product with a negative incremental profit. The 64-load size of detergent 1, from retailer 66, has a maximum discount of $3.75 and an optimized discount of $2.16. The incremental profit for a sale of the 64-load size of detergent 1, from retailer 66, is $1.59. The 32-load size of detergent 2 from retailer 66 has a maximum discount of $1.50 and an optimized discount of $0.31. The incremental profit for a sale of the 32-load size of detergent 2, from retailer 66, is $1.19. The 64-load size of detergent 3, from retailer 68, has a maximum discount of $3.75 and an optimized discount of $3.99. The optimum discount exceeds the maximum discount, so the incremental profit for the offer is negative.

The 35-load size of detergent 4, from retailer 70, has a maximum discount of $1.50 and an optimized discount of $0.57. The incremental profit for a sale of the 35-load size of detergent 4, from retailer 70, is $0.93. The 96-load size of detergent 5, from retailer 68, has a maximum discount of $4.00 and an optimized discount of $0.00. The incremental profit for a sale of the 96-load size of detergent 5, from retailer 68, is $4.00. The 96-load size of detergent 4, from retailer 70, has a maximum discount of $3.75 and an optimized discount of $3.25. The incremental profit for a sale of the 35-load size of detergent 4 from retailer 70 is $0.50.

Consumer service provider 72 evaluates the potential optimized discount offers negotiated by retailer agents and consumer agents and selects the desired number to display to consumer 62. Consumer service provider 72 uses profit share to select the desired number of offers for presentation to consumer 62. Consumer service provider 72 multiplies the incremental profit share percentage to determine the total revenue shared. The profit share amount could also be provided as a flat fee, such as $0.10 per presentation to consumer 62. Profit share amount can also be provided as an amount of incremental profit that exceeds a threshold, or alternatively all incremental profit up to a threshold. For example, a retailer could elect to share any incremental profit exceeding $0.50 with consumer service provider 72. The selected optimum discount offer also provides consumer 62 with the best possible shopper value because retailer agents 140-144 and consumer agents 136-138 negotiate the optimum offers specifically to reach the maximum shopper value.

Continuing with FIG. 12b, consumer service provider 72 evaluates optimum discount offers to select which offers to send to consumer 62. Consumer service provider 72 multiplies the incremental profit by the profit share percentage submitted by each retailer for each detergent product that consumer 62 has an interest in purchasing. The product of the two numbers is the profit share or revenue amount that consumer service provider 72 will receive if the offer is selected for consumer 62 or if consumer 62 purchases the product using the offer. Consumer service provider 72 multiplies the negative $1.15 incremental profit of the 30-load size of detergent 1 by the 10% share percentage indicated by retailer 66 to reach a share amount of negative $0.12. Consumer service provider 72 multiplies the $1.59 incremental profit of the 64-load size of detergent 1 by the 10% share percentage indicated by retailer 66 to reach a shared revenue amount of $0.16. Consumer service provider 72 multiplies the $1.19 incremental profit of the 32-load size of detergent 2 by the 10% share percentage indicated by retailer 66 to reach a shared revenue amount of $0.12. Consumer service provider 72 multiplies the negative $0.24 incremental profit of the 64-load size of detergent 3 by the 5% share percentage indicated by retailer 68 to reach a share amount of negative $0.01. Consumer service provider 72 multiplies the $0.93 incremental profit of the 35-load size of detergent 4 by the 3% share percentage indicated by retailer 70 to reach a shared revenue amount of $0.03. Consumer service provider 72 multiplies the $4.00 incremental profit of the 96-load size of detergent 5 by the 5% share percentage indicated by retailer 68 to reach a shared revenue amount of $0.20. Consumer service provider 72 multiplies the $0.50 incremental profit of the 96-load size of detergent 4 by the 3% share percentage indicated by retailer 70 to reach a shared revenue amount of $0.02.

Consumer service provider 72 selects the desired number of offers corresponding to the greatest shared revenue amounts to submit to consumer 62. In the present example, consumer service provider 72 selects the 96-load size of detergent 5, from retailer 68, as the product and optimized discount offer to place in the shopping list of consumer 62 because the 96-load size of detergent 5 had the highest shared revenue amount of $0.20.

Retailer 66 wants one of its detergent products placed in the shopping cart in lieu of the retailer 68 detergent next time consumer 62 indicates an intent to purchase a detergent product. Retailer 66 must increase either the share percentage or maximum discount so that the total share amount for one of the retailer 66 detergents exceeds the $0.20 share amount for the selected retailer 68 detergent. In FIG. 13a, retailer 66 increases the profit share percentage to 25% for all retailer 66 detergent products. Retailers 68 and 70 maintain the share amounts of 5% and 3%. Consumer 62 again indicates an intent to purchase a detergent product to consumer service provider 72.

FIG. 13b illustrates consumer service provider selecting the offer resulting in the highest shared revenue. The largest incremental profit for retailer 66 detergent is still $1.59 corresponding to the 64-load size of detergent 1, since retailer 66 did not increase any maximum discounts. The new 25% share amount multiplied by the incremental profit give a shared revenue of $0.40. The $0.40 share amount of the 64-load size of detergent 1 is now the greatest share amount among the competing detergent products. Consumer service provider 72 places the 64-load size of detergent 1 on the shopping list for consumer 62 with the price reflecting application of the optimum discount for consumer 62. Consumer purchases the 64-load size of detergent 1 at the discounted price, receiving a subjective value as good as or better than any other value available to consumer 62 without a discount applied. By providing consumer 62 with individualized offers on high value products, consumer service provider 72 helps consumer receive the best subjective value per dollar when shopping. Consumer service provider 72 also enables retailer 66 to make additional sales where a product sold by retailer 66 would provide a best value for consumer 62 at a discounted price. Consumer service provider 72 controls the commerce system, improving the consumer value and retailer profit, by selecting discount offers for consumer 62 based on shared profit.

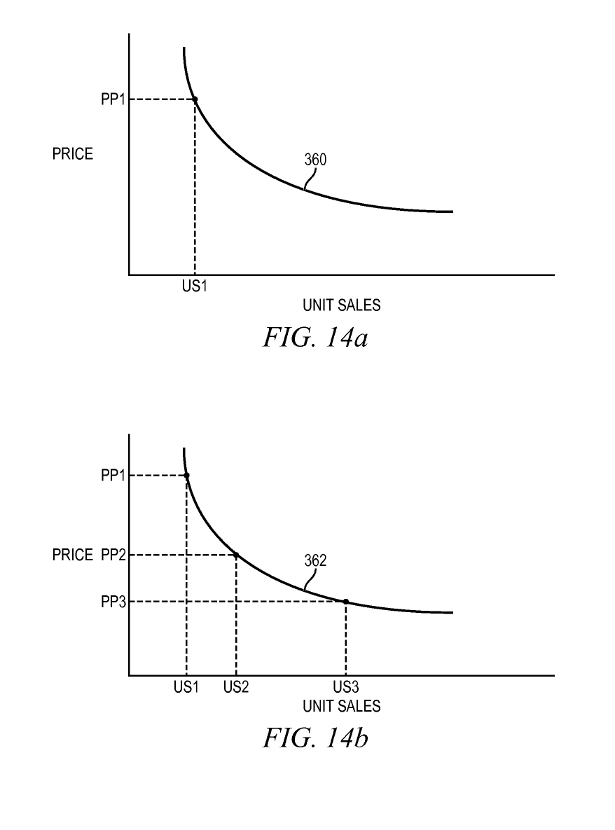

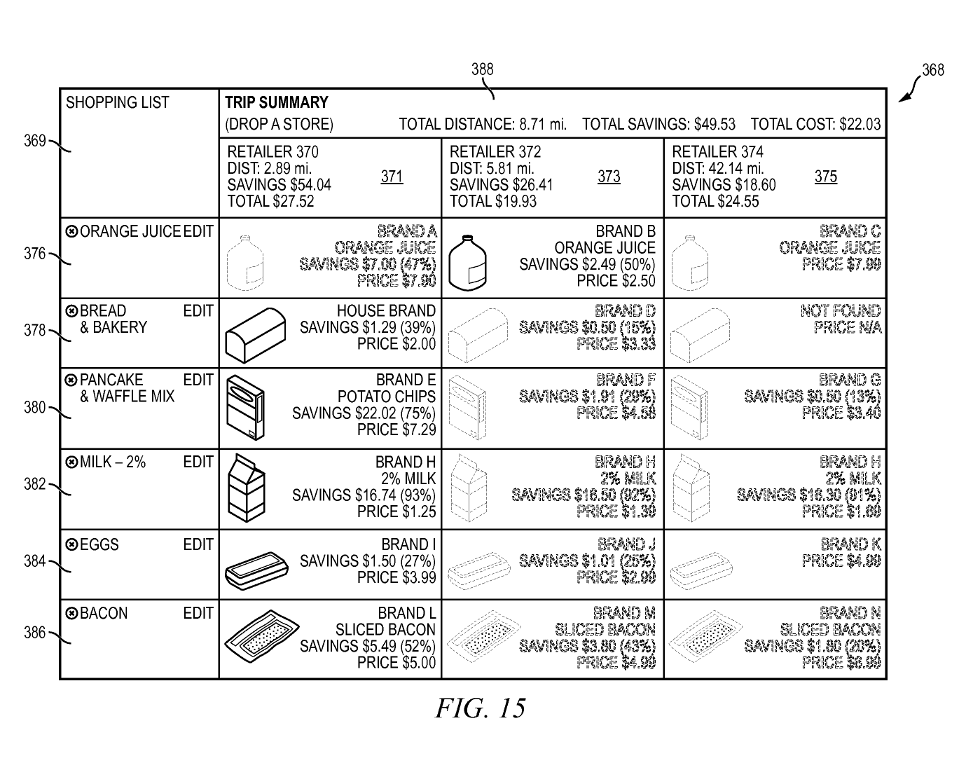

To explain part of the role of consumer service provider 72, first consider demand curve 360 of price versus unit sales, as shown in FIG. 14a. In demand curve 360 for a given product P, as price increases, unit sales decrease and, conversely, as price decreases, unit sales increase. At price point PP1, the unit sales are US1. The revenue attained by the retailer is given as PP1*US1. Thus, using a conventional mass marketing strategy as described in the background, if the retailer offers an across the board discounted offer or sale price PP1 to all consumers, e.g., via a newspaper advertisement, then, according to demand curve 360, the expected unit sales will be US1 and the retailer revenue is PP1*US1. That is, the consumers with a purchasing decision threshold of PP1 will buy product P and the consumers with a purchasing decision threshold less than PP1 will not buy product P. The conventional mass marketing approach has missed the opportunity to sell product P at price points below PP1. The retailer loses potential revenue that could have been earned at lower price points.

Now consider demand curve 362 in FIG. 14b with multiple price points PP1, PP2, and PP3, each capable of generating a profit for the retailer. The number of price points that can be assigned on demand curve 362 differ by as little as one cent, or a fraction of a cent. With a consumer targeted marketing approach, the consumers with a purchasing decision threshold of PP1 will buy product P at that price, the consumers with a purchasing decision threshold of PP2 will buy product P at that price, and the consumers with a purchasing decision threshold of PP3 will buy product P at that price. The retailer now has the potential revenue of PP1*US1+PP2*(US2−US1)+PP3*(US3−US2). Although the profit margins for price points PP2 and PP3 are less than price point PP1, the unit sales US2 and US3 will be greater than unit sales US1. The total revenue for the retailer under FIG. 14b is greater than the revenue under FIG. 14a.

Under the consumer targeted marketing approach, each individual consumer receives a price point with an individualized discounted offer, i.e., PP1, PP2, or PP3, from the retailer for the purchase of product P. The individualized discounted offer is set according to the individual consumer price threshold that will trigger a positive purchasing decision for product P. The task is to determine an optimal pricing threshold for product P associated with each individual consumer and then make that discounted offer available for the individual consumer in order to trigger a positive purchasing decision. In other words, the individualized discounted offer involves consumer C1 being offered price PP1, consumer C2 being offered price PP2, and consumer C3 being offered price PP3 for product P. Each consumer C1-C3 should make the decision to purchase product P, albeit, each with a separate price point set by an individualized discounted offer. Consumer service provider 72 makes possible the individual consumer targeted marketing with the consumer-specific, personalized “one-to-one” offers as a more effective approach for retailers to maximize revenue as compared to the same discounted price for every consumer under mass marketing. Consumer service provider 72 becomes the preferred source of retail information for the consumer, i.e., an aggregator of retailers capable of providing one-stop shopping for many purchasing options. The individualized discounted offers enable market segmentation to the “one-to-one” level with each individual consumer receiving personalized pricing for a specific product.

With respect to pricing, each retailer has two price components: regular price and discounted offers from the regular price that are variable over time and specific to each consumer. The net price to consumer 62 is the regular price less the individualized discounted offer for that consumer. To determine optimal individualized discount needed to achieve a positive consumer purchasing decision for product P from consumer 62, consumer service provider 72 considers the individualized discounts from each retailer 66-70. In one embodiment, the individualized discount can be a default discount determined by the retailer or consumer service provider 72 on behalf of the retailer. The default discount is defined to provide a reasonable profit for the retailer as well as reasonable likelihood of placement on optimized shopping list 120, i.e., the default-discounted offer is selected to be competitive with respect to other retailers.

Consumer service provider 72 generates for each specific consumer a one to one offer 154 for each product on optimized shopping list 120, as shown in FIGS. 7b-7c. The individualized discounted offer is crafted for each individual consumer based on a product specific preference value of the consumer weighted attributes. Each consumer receives an individualized “one-to-one” offer 154. That is, the optimized shopping list for consumer 62 will have a one to one offer 154 for product P1 based on the product specific preference value of the consumer 62 weighted attributes. The optimized shopping list for consumer 64 may have a different one to one offer 154 for the same product P1 based on the product specific preference value of the consumer 64 weighted attributes. The one to one offer 154 should be set to trigger a positive purchasing decision for each consumer. The products that show up on optimized shopping list 120 are the products of interest to the consumer offered at the most valued price.

Consumer service provider 72 simultaneously assists retailers and consumers by controlling the commerce system. The consumer service provider automates pre-shopping for the consumer while at the same time providing an easy-to-manage promotion system to retailers to reduce economic risk. Consumer 62 receives a one-to-one offer that takes into consideration the relative value of products to consumer 62. Consumer service provider 72 knows which products the consumer is considering and where the price thresholds for switching between products occur. Consumer service provider 72 uses the consumer information to create competition between retailers to provide one of a limited number of offers to consumer 62. When the consumer receives only one product offer, for example, retailers must compete with one another to have their offer selected. Consumer service provider 72 provides retailer with a promotion-management system requiring a retailer to decide only on a profit share amount and maximum discount. The retailer easily manages the discount promotions with reduced time and resources invested. The retailer also reduces economic risk when over discounting is eliminated by offers from consumer service provider 72. Consumer service provider controls the commerce system by comparing options under consideration and predicting the most valuable option for consumer 62 while limiting economic risk of the retailer 66. As a result, the consumer gets the most valuable product available at an optimal discount with reduced decision stress. The retailer makes an additional sale at an optimum price to increase sales revenue. The consumer service provider shares in the increased sales revenue of the retailer. Thus, each member of the commerce system involved in the purchasing decision benefits from the personal discount offers. The interests of consumer 62, retailer 66, and consumer service provider 72 align.

The optimal discounted offer tipping point (P_{TIP}) for consumer 62 to make a positive purchasing decision between two products can be determined according to P_{TIP}=CV_{K}−CV_{K}*(CV_{I}−P_{I})/CV_{I}, where CV_{K} is the consumer value of product K, CV_{I} is the consumer value of product I, and P_{I} is the price of product I.

Retailers 66-70 do not necessarily want to offer every consumer 62-64 the maximum retailer acceptable discount as that would minimize profit for the retailer. Consumer service provider 72 must determine the price tipping point for consumer 62 to make a positive purchasing decision, i.e., the lowest individualized discounted price that would entice the consumer to purchase one product. Any product with a net value less than one or negative net value given the maximum retailer acceptable discount is eliminated because there is no practical discount, i.e., a discount that still yields a profit for the retailer, that the retailer could offer which would entice consumer 62 to purchase the product.

In each of the above examples of determining net value for consumer 62, multiple brands and/or retailers for a single product can be placed on optimized shopping list 120. Consumer service provider 72 can place the top two or top three net value brands and/or retailers on optimized shopping list 120, and allow the consumer to make the final selection and purchasing decision.

The consumer patronizes retailers 66-70, either in person or online, with optimized shopping list 120 and individualized discounted offers 154 from consumer service provider 72 in hand, and makes purchasing decisions based on the recommendations on the optimized shopping list. The optimized shopping list 120 gives consumer 62 the ability to evaluate one or more recommended products, each with an individualized discount customized for consumer 62 to make a positive purchasing decision. The consumers can rely on consumer service provider 72 as having produced a comprehensive, reliable, and objective shopping list in view of the consumer's profile and weighted product preferences, as well as retailer product information, that will yield the optimal purchasing decision to the benefit of the consumer. The individualized discounted price should be set to trigger the purchasing decision. Consumer service provider 72 helps consumers quantify and develop confidence in making a good decision to purchase a particular product from a particular retailer at the individualized “one-to-one” discounted offer 154. While the consumer makes the decision to place the product in the basket for purchase, he or she comes to rely upon or at least consider the recommendations from consumer service provider 72, i.e., optimized shopping list 120 and individualized discounted offers 154 contribute to the tipping point for consumers to make the purchasing decision. The consumer model generated by consumer service provider 72 thus in part controls many of the purchasing decisions and other aspects of commercial transactions within commerce system 60.

The optimized shopping list 120 with individualized discounts can be transferred from consumer computers 164-166 to cell phone 116. Consumers 62-64 patronize retailers 66-70, each with optimized shopping list 120 from consumer service provider 72 in hand and make purchasing decisions based on the recommendations on the optimized shopping list. The individualized discounted prices are conveyed to retailers 66-70 by electronic communication from cell phone 116 to the retailer's checkout register. The discounted pricing can also be conveyed from consumer computer 164-166 directly to retailers 66-70 and redeemed with a retailer loyalty card assigned to the consumer. Retailers 66-70 will have a record of the discounted offers and the loyalty card will match the consumer to the discounted offers on file. In any case, consumers 62-64 each receive an individualized discounted offer as set by consumer service provider 72.

In other cases, retailer 66 may want to incentivize consumer 62 to conduct most if not all their shopping at the retailer's store, i.e., retailers want to encourage one-stop shopping to their store. Retailer 66 may utilize a loss leader marketing approach by selling certain products at below-cost pricing with the expectation of making up the lost profit on other products purchased by consumer 62 at regular or higher margin.

The consumers can rely on consumer service provider 72 as having produced a comprehensive, reliable, and objective shopping list in view of the consumer's profile and preference level for each weighted product attribute, as well as retailer product information and the individualized discounted offer, that will yield the optimal purchasing decision for the benefit of the consumer. Consumer service provider 72 helps consumers 62-64 quantify and evaluate, from a myriad of potential products on the market from competing retailers, a smaller, optimized list objectively and analytically selected to meet their needs while providing the best net value. Consumers 62-64 will develop confidence in making a good decision to purchase a particular product from a particular retailer. While the consumer makes the decision to place the product in the basket for purchase, he or she comes to rely upon or at least consider the recommendations from consumer service provider 72, i.e., optimized shopping list 120 with the embedded individualized discount contributes to the tipping point for consumers to make the purchasing decision. The consumer model generated by consumer service provider 72 thus in part controls many of the purchasing decisions and other aspects of commercial transactions within commerce system 60.

The purchasing decisions actually made by consumers 62-64 while patronizing retailers 66-70 can be reported back to consumer service provider 72 and retailers 66-70. Upon completing the checkout process, the consumer is provided with an electronic receipt of the purchases made. The electronic receipt is stored in cell phone 116, downloaded to consumer service provider 72, and stored in databases 130-134 for comparison to optimized shopping list 120. The product information in databases 130-134 can be updated from the electronic receipt. That is, the actual prices for the products on optimized shopping list 120 as charged by the retailer can be confirmed and updated as indicated. The actual purchasing decisions made when patronizing retailers 66-70 may or may not coincide with the preference levels or weighted attributes assigned by the consumer when constructing the original shopping list. For example, in choosing the canned soup, consumer 62 may have decided at the time of making the purchasing decision that one product attribute, e.g., product ingredients, was more important than another product attribute, e.g., brand. Consumer 62 made the decision to deviate from optimized shopping list 120, based on product ingredients, to choose a different product from the one recommended on the optimized shopping list. Consumer service provider 72 can prompt consumer 62 for an explanation of the deviation from optimized shopping list 120, i.e., what product attribute became the overriding factor at the moment of making the purchasing decision. Consumer service provider 72 learns from the actual purchasing decisions made by consumer 62 and can update the preference levels of the consumer weighted product attributes as well as the product switching thresholds. The preference level for product ingredients can be increased and/or the preference level for brand can be decreased. The revised preference levels for the consumer weighted product attributes will improve the accuracy of subsequent optimized shopping lists and optimized, one-to-one discounts. The pricing and other product information uploaded from cell phone 116 after consumer check-out to consumer service provider 72 can also be used to modify the product information, e.g., pricing, in databases 130-134. Consumer service provider 72 can also guarantee discounts by identifying price discrepancies between the electronic receipt and the original shopping list.

Consumers 62-64 can also utilize consumer service provider 72 without a product of interest necessarily being on optimized shopping list 120. While patronizing retailer's store with or without optimized shopping list 120, the consumer can take a photo of the barcode of any product of interest using cell phone 116. The photo is transmitted to consumer service provider 72. Consumer service provider 72 reviews the consumer weighted attributes for that product and determines the individualized discounted offer available from the retailer for that consumer on the product of interest, as well as competing products. If there is no consumer weighted attribute on file for the product of interest, then consumer service provider 72 can offer a default individualized discount determined by the personal assistant engine and/or the retailer. The individualized discount is transmitted back to the consumer and displayed on cell phone 116. The consumer can make the purchasing decision at that moment with knowledge of the available individualized discounted offer. With the benefits of consumer service provider 72, consumers 62-64 need no longer pay the stated regular shelf price for virtually any product. Consumers 62-64 can receive an individualized discounted offer for any products at any time.

As another feature of consumer service provider 72, retailers 66-70 can allocate marketing funds to the consumer service provider for distribution as individualized discounts to consumers 62-64. The marketing funds can also originate with manufacturers 32, distributors 36, or other member of commerce system 30, see FIG. 2. Consumer service provider 72 distributes the marketing funds in the form of individualized discounted offers when compiling optimized shopping list 120. By utilizing consumer service provider 72, retailers 66-70 are not just randomly distributing a discounted offer, e.g., as with mailbox flyers and coupons, with hope that a consumer might purchase a product from the retailer based on the general discount. By teaming with consumer service provider 72, retailers 66-70 are reaching a targeted market segment, e.g., a specific consumer that has already acknowledged a need or interest for the product by creating the shopping list via interface 190 and 200. The individualized discount from retailers 66-70 is offered to the consumer who is likely to buy or at least has expressed interest in the retailer's product. Retailers 66-70 will have reached the consumer at or near the tipping point in the purchasing decision process. Since the marketing funds are used to support the individualized discounts and the discounts are made available to the consumer at the point of making the purchasing decision via optimizing shopping list 120, and the actual purchasing decision can be measured and correlated by the electronic receipt with the optimized shopping list, the allocation of marketing funds can be tracked by performance based criteria and reported back to retailers 66-70. Retailers 66-70 will know with a level of certainty that the marketing dollar is indeed generating additional revenue and profit.

Consumer service provider 72 may use a business model which involves no cost to the consumers for use of consumer service provider 72 but rather relies upon a shared percentage of the incremental revenue or profit (used herein interchangeably) earned by choosing the least individualized discounted offer that will result in a positive purchasing decision by the consumer. Retailers 66-70 may share 0-100% of the incremental revenue or profit associated with the various individualized discounts that can be offered to the consumer as compensation to consumer service provider 72. The sharing percentage to consumer service provider 72 will be greater than zero because 0% gives little or no motivation for consumer service provider 72 to recommend the retailer's product. Likewise, the sharing percentage will be less than 100% because that level of sharing would leave no portion for retailers 66-70. In one embodiment, the sharing percentage to consumer service provider 72 is 30-50% of the incremental revenue or profit from the least individualized discounted offer that will result in a positive purchasing decision by the consumer.

FIG. 15 Illustrates an interface 368 for consumer 62 to review shopping list 369 after an optimization process using a consideration set to identify products of interest. The optimized shopping list includes separate trips with different products for each of the competing retailers under consideration. Consumer service provider 72 recommends retailer 370 for trip 371 and includes the products available at retailer 370 that satisfy shopping list 369 and provide the greatest value to consumer 62. Consumer service provider 72 recommends retailer 372 for trip 373 and includes the products available at retailer 372 that satisfy shopping list 369 and provide the greatest value to consumer 62. Consumer service provider 72 recommends retailer 374 for trip 375 and includes the products available at retailer 375 that satisfy shopping list 369 and provide the greatest value to consumer 62. The optimization engine processes parameters including minimum trip distance, maximum savings, minimizing the total cost, and maximizing the item coverage at the selected retailers. The interface indicates the top product considered from each of the selected retailers 370, 372, and 374.

Consumer 62 submits shopping list 369 to consumer service provider 72 to indicate an intent to buy products listed in rows 376, 378, 380, 382, 384, and 386 of shopping list 369. For example, in row 376, consumer 62 indicates an intent to purchase orange juice. Consumer service provider 72 compares orange juice products available at retailers 370, 372, and 374 to determine which orange juice product has the highest value to consumer 62 once a selected individualized offer is applied.

Retailer 370 offers several orange juice products, including brand A orange juice. Retailer 370 normally lists brand A orange juice at $14.90. However, consumer service provider 72 selects an individualized offer for consumer 62 of $7.90 for brand A orange juice. The individualized offer makes brand A orange juice the best value for an orange juice product from retailer 370. Consumer service provider 72 lists brand A orange juice on trip 371 to retailer 370 as the orange juice product selected.

Retailer 372 offers several orange juice products, including brand B orange juice. Retailer 372 normally lists brand B orange juice at $4.99. However, consumer service provider 72 selects an individualized offer for consumer 62 of $2.50 for brand B orange juice. The individualized offer makes brand B orange juice the best value for an orange juice product from retailer 372. Consumer service provider lists brand B orange juice on trip 373 to retailer 372 as the orange juice product selected.

Retailer 374 offers several orange juice products, including brand C orange juice. Retailer 374 normally lists brand C orange juice at $7.99. Consumer service provider does not make a discount offer on brand C orange juice because the manufacturer or distributer of brand C orange juice has not provided a maximum discount or a profit share amount. Nevertheless, brand C orange juice provides the best value for an orange juice product from retailer 374. Consumer service provider lists brand C orange juice on trip 375 to retailer 374 as the orange juice product selected.

Consumer service provider 72 compares the value of the orange juice product selected for each retailer 370, 372, and 374 for consumer 62 to identify brand B orange juice at retailer 372 as the best value. Brand B orange juice is highlighted by deemphasizing the competing brand A and C orange juice products, e.g., by greying the products out, fading the products so that the images are translucent. Brand B orange juice can also be emphasizing the brand B product by highlighting brand B with bold print or a different color around the product. Consumer 62 reviews the orange juice selection using interface 368. Consumer 62 edits product recommendations from consumer service provider 72 by selecting edit in row 376 of shopping list 369, corresponding with orange juice. Consumer 62 removes the orange juice products from the shopping list and recommended trips by pressing the X button in row 376 of shopping list 369 that corresponds with orange juice.

In row 378, consumer 62 indicates an intent to purchase a bread & bakery product. Consumer service provider 72 compares bread products available at retailers 370, 372, and 374 to determine which bread product is in the consideration set and has the highest value to consumer 62 once an individualized offer for consumer 62 is applied.

Retailer 370 offers several bread product products, including house brand bread product. Retailer 370 normally lists the house brand bread product at $3.29. However, consumer service provider 72 selects an individualized offer for consumer 62 of $2.00 for the house brand bread product. The individualized offer makes the house brand bread product the best value for a bread product from retailer 370. Consumer service provider 72 lists the house brand bread product on trip 371 to retailer 370 as the selected bread product.

Retailer 372 offers several bread products, including brand D bread product. Retailer 372 normally lists brand D bread product at $3.83. However, consumer service provider 72 selects an individualized offer for consumer 62 of $2.50 for brand D bread product. The individualized offer makes brand D bread product the best value for a bread product from retailer 372. Consumer service provider lists brand D bread product on trip 373 to retailer 372 as the selected bread product.

Retailer 374 offers several bread products, but none of the bread products at retailer 374 are included in the consideration set of bread products for consumer 62. Consumer service provider 72 indicates that no bread product meeting the criteria for consumer 62 was found at retailer 374.

Consumer service provider 72 compares the value of each bread product for consumer 62 and identifies the house brand bread product at retailer 372 as the best value. The selected house brand bread product is highlighted in interface 368 by deemphasizing the competing brand C bread product by greying the product, fading the product. Consumer 62 reviews the bread product selection using interface 368. Consumer 62 edits product recommendations from consumer service provider 72 by selecting edit in row 378 of shopping list 369 corresponding with bread & bakery and selecting a different retailer, bread product, or both. Consumer 62 removes the bread products from the shopping list and recommended trips by pressing the X button in row 378 of shopping list 369 corresponding with the bread products.

In row 380, consumer 62 indicates an intent to purchase a pancake & waffle mix product. Consumer service provider 72 compares pancake and waffle mix products along with other products of interest available at retailers 370, 372, and 374 to determine which product is in the consideration set and has the highest value to consumer 62 once an individualized offer for consumer 62 is applied.

Retailer 370 offers brand E potato chips that consumer service provider 72 has associated with pancake and waffle mix as an item that consumer 62 would likely be interested in. Retailer 370 normally lists brand E potato chips at $29.31. However, consumer service provider 72 selects an individualized offer for consumer 62 of $7.29 to purchase brand E potato chips. The individualized offer makes brand E potato chips the best value for the potato chip product from retailer 370. Consumer service provider 72 lists brand E potato chips on trip 371 to retailer 370 as the selected product from the pancake and waffle mix category on line 380.

Retailer 372 offers several pancake & waffle mix products, including brand F pancake & waffle mix. Retailer 372 normally lists brand F pancake & waffle mix at $4.99. However, consumer service provider 72 selects an individualized offer for consumer 62 of $2.50 for brand F pancake & waffle mix. The individualized offer makes brand F pancake & waffle mix the best value for a pancake & waffle mix product available at retailer 372. Consumer service provider lists brand F pancake & waffle mix on trip 373 to retailer 372 as the pancake & waffle mix product.

Retailer 374 offers several pancake & waffle mix products, including brand G pancake & waffle mix. Retailer 374 normally lists brand G pancake & waffle mix at $7.99. Consumer service provider does not make a discount offer on brand G pancake & waffle mix because the manufacturer or distributer of brand G pancake & waffle mix has not provided a maximum discount or a profit share amount. Nevertheless, brand G pancake & waffle mix provides the best value for a pancake & waffle mix product available from retailer 374. Consumer service provider lists brand G pancake & waffle mix on trip 375 to retailer 374 as the pancake & waffle mix product providing the best value.

Consumer service provider 72 compares the value of each pancake & waffle mix product for consumer 62 and identifies brand F potato chips at retailer 370 as the best value. Brand F potato chips are highlighted by deemphasizing the competing brand E and C pancake & waffle mix products, i.e., greying the products in interface 368 or fading the products in interface 368. Brand F pancake & waffle mix can be further emphasized directly by, i.e., by highlighting or bolding the brand F product in interface 368. Consumer 62 reviews the pancake & waffle mix selection using interface 368. Consumer 62 edits product recommendations from consumer service provider 72 by selecting edit in row 380 of shopping list 369 corresponding with pancake & waffle mix. Consumer 62 removes the pancake & waffle mix products from the shopping list and recommended trips by pressing the X button in row 380 of shopping list 369 corresponding with pancake & waffle mix.

In rows 384 and 386, consumer service provider 72 evaluates the consideration sets for consumer 62 intending to buy eggs and bacon. Consumer 62 includes brand I, brand J, and brand K eggs in the consideration set for egg products. Brands I, J, and K eggs are evaluated from each retailer 370, 372, and 374 that sells the brands to determine which product is most valuable to consumer 62. Without any discount applied, consumer 62 would purchase brand J eggs for $4.00 at retailer 372. Brand I submits a maximum discount of $3.00 and a profit share of 25%. Consumer service provider 72 identifies $1.50 as the optimum discount from brand I at retailer 370. Consumer service provider places brand I eggs on trip 371 for purchase from retailer 370 because brand I eggs offer the best value to consumer 62 at the discounted $3.99 price. The sale of brand I eggs at the reduced price of $1.50, which is $1.50 less than the authorized maximum discount, result in an incremental profit of $1.50. Consumer service provider receives 25% of the $1.50 incremental profit, or $0.38.

Interface 368 includes a shopping trip summary in block 388. The shopping trip summary displays details regarding the trip suggested to consumer 62 by consumer service provider 72. The trip summary changes as consumer 62 adds or removes retail stores or products from shopping list 369. For example, shopping at retailer 374 requires a 42.14 mile trip from the location of consumer 62. If consumer 62 presses the Edit button on line 386 of shopping list 369 and selects brand N bacon from retailer 374, removing brand L bacon from retailer 370, the distance of the trip will be increased to reflect the greater distance traveled by consumer 62. The total savings for the items selected on list 369 is displayed in block 388. In the present example, consumer 62 has a shopping trip planned that includes retailers 370 and 372. The total savings on the goods selected from both retailers is $49.53. The total cost of the goods selected at both retailers is $22.03.

Each shopping trip 371, 373, and 375 also includes details specific to the trip. For example, shopping trip 371 includes information regarding a potential trip by consumer 62 to purchase all goods on shopping list 369 at retailer 370. If consumer 62 purchased brand A orange juice, house brand bread, brand E potato chips, brand H milk, brand I eggs, and brand L bacon, all at retailer 370, the travel distance would be 2.89 miles. The savings on the goods purchased from retailer 370 would total to $54.04. The total cost of goods purchased from retailer 370 would be $27.52. Interface 368 includes similar information for each retailer considered by consumer service provider 72 suggesting products.

Consumer service provider 72 controls the commerce system by providing optimized shopping lists including individualized offers to consumer 62. Consumer 62 uses suggestions from consumer service provider 62 to purchase products providing the greatest value to consumer 62 at a discounted price. Consumer 62 is able to reduce pre-shopping time and increase effectiveness by submitting a consideration set to consumer service provider to evaluate and select a product. Individualized offers from consumer service provider 72 eliminate economic risk for a retailer. The retailer gains an additional sale by offering an individualized discount price, tailored to a specific consumer, to evoke a positive purchase decision without over discounting the product.

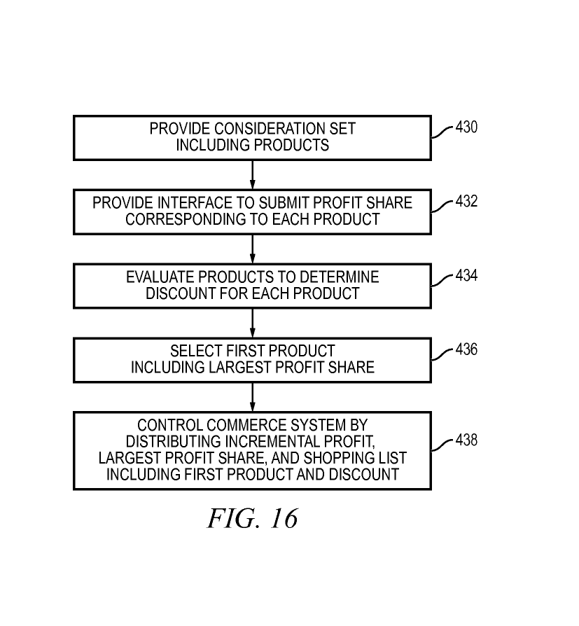

FIG. 16 illustrates a process for controlling a commerce system by enabling the consumer to select the products for purchase from retailers providing high value. In step 430, a consideration set is provided including a plurality of products. In step 432, an interface is provided to submit a profit share corresponding to each product. In step 434, products are evaluated to determine a discount for each product. In step 436, a first product is selected including a largest profit share. In step 438, the commerce system is controlled by distributing an incremental profit, the largest profit share, and a shopping list including the selected product and the discount.

In summary, the consumer service provider in part controls the movement of goods between members of the commerce system. The consumer service provider offers consumers comparative shopping services, to aid the consumer in making purchase decisions by optimizing the shopping list according to consumer values for products. The optimized shopping list helps the consumer to make the purchasing decision based on comprehensive, reliable, and objective retailer product information, as well as an individualized discounted offer. By providing discount offers based on relative product value, a consumer service provider helps the consumer to purchase competing products at a subjective best value with a minimal time investment in pre-shopping. Individualized discount offers can be made to entice a positive purchasing decision from consumers based on a profit share. The consumer makes purchases within the commerce system based on the optimized shopping list and product information compiled by the consumer service provider. By following the recommendations from the consumer service provider, the consumer can receive the most value for the money while retailers make additional sales. The consumer service provider also maximizes retailer profit by determining an optimum, one-to-one offer for each consumer that will bring the consumer to the tipping point of a purchasing decision. The one-to-one offers eliminate economic risk to the retailer associated with offering discounts. Consumer service provider selects a predetermined number of the one-to-one offers to distribute to the consumer based on the offer of the retailer that shares the largest portion of the resulting incremental profit. Consumer service provider controls the commerce system by distributing shopping lists and incremental profits. The consumer service provider becomes the preferred source of retail information and budgeting tools for the consumer, i.e., an aggregator of retailers capable of providing one-stop shopping.

By providing the consumer an optimized shopping list to make purchasing decisions based on comprehensive, reliable, and objective retailer product information, as well as an individualized discounted offer, the members of the commerce system cooperate in controlling the flow of goods. Retailers benefit by selling more products with a higher profit margin. Consumers receive the best value for the dollar for needed products. Consumer service provider enables an efficient and effective connection between the retailers and consumers while sharing in the increased profit of the retailer. Thus, each member of the commerce system that is involved in the purchasing decision benefits from the personal discount offers and the interests of each member align.

In particular, enabling the consumer to make purchasing decisions based on the optimized shopping, e.g., products with the highest subjective value in a category, operates to control activities within the commerce system. The shopping list and one-to-one offers in part control the business interaction of retailers, consumers, and consumer service provider. Retailers offer products for sale. Consumers make decisions to purchase the products. The one-to-one offers influence how consumer service provider connects the retailers and consumers to control activities within the commerce system.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling a commerce system, comprising:
providing a consideration set including a plurality of products;
providing an interface to submit a profit share corresponding to each of the products;
evaluating the products to determine a discount for each of the products;
selecting a first product from the products including a largest profit share; and
controlling the commerce system by distributing the largest profit share, an incremental profit corresponding to the first product, and a shopping list including the first product and discount.

2. The method of claim 1, further including:
determining a value of each of the products to identify a maximum value; and
determining the discount for each of the products to increase the value of each of the products to the maximum value.

3. The method of claim 2, further including:
providing a price per use for a product in the consideration set; and
comparing the price per use to a target price per use for the product to determine the value of the product.

4. The method of claim 1, further including saving the consideration set in a computer readable storage medium.

5. The method of claim 1, further including:
providing a second interface to submit a consumer value of the first product relative to a second product;
providing a target price for the second product; and
determining a target price for the first product by increasing the target price for the second product by the consumer value.

6. The method of claim 1, wherein the profit share corresponding to the first product is a portion of the incremental profit.

7. A method of controlling a commerce system, comprising:
providing a set of products;
providing an interface to submit a profit share corresponding to each of the products;
selecting a first product from the products including a largest profit share; and
controlling the commerce system by distributing an incremental profit corresponding to the first product and a shopping list including the first product.

8. The method of claim 7, further including:
determining a value of each of the products to identify a maximum value; and
determining a discount for each of the products to increase the value of each of the products to the maximum value.

9. The method of claim 8, further including:
accessing the set of products to provide a price per use for each of the products; and
comparing the price per use to a target price per use for each of the products to determine the value of each of the products.

10. The method of claim 7, further including:
providing a maximum discount; and
determining a difference between the discount for the first product and the maximum discount to calculate the incremental profit.

11. The method of claim 10, wherein the profit share corresponding to the first product includes a portion of the incremental profit.

12. The method of claim 7, further including:
providing a consumer value of the first product relative to a second product;
providing a target price for the second product; and
increasing the target price for the second product by the consumer value to determine a target price for the first product.

13. The method of claim 7, further including saving a consideration set including the products in a computer readable storage medium.

14. A method of controlling a commerce system, comprising:
providing a set of products including a profit share for each product;
selecting a product from the set of products based on the profit share; and
distributing an incremental profit corresponding to the selected product.

15. The method of claim 14, further including providing a price per use for the product.

16. The method of claim 15, further including:
comparing the price per use to a target price per use for the product to determine a value of the product; and
determining a discount to increase the value of the product.

17. The method of claim 14, further including:
providing a maximum discount for the product; and
determining a difference between the discount for the product and the maximum discount to calculate the incremental profit.

18. The method of claim 17, wherein the profit share corresponding to the product includes a portion of the incremental profit.

19. The method of claim 17, wherein the discount for the product is less than a maximum discount.

20. A computer program product usable with a programmable computer processor having a computer readable program code embodied in a non-transitory computer usable medium for controlling a commerce system, comprising:
providing a set of products;
providing an interface to submit a profit share corresponding to each of the products;
selecting a first product from the products including a largest profit share; and
controlling the commerce system by distributing an incremental profit corresponding to the first product and a shopping list including the first product.

21. The computer program product of claim 20, further including:
providing a maximum discount; and
determining a difference between the discount for the first product and the maximum discount to calculate the incremental profit.

22. The computer program product of claim 21, wherein the profit share corresponding to the first product includes a portion of the incremental profit.

23. The computer program product of claim 21, wherein the discount for the first product is less than a maximum discount.

24. The computer program product of claim 21, further including:
determining a value of each of the products to identify a maximum value; and
determining the discount for each of the products to increase the value of each of the products to the maximum value.

25. The computer program product of claim 24, further including:
accessing the set of products to provide a price per use for each of the products; and
comparing the price per use to a target price per use for each of the products to determine the value of each of the products.
